(19) United States
(12) Patent Application Publication
(10) Pub. No.: US 2026/0225937 A1
(43) Pub. Date: Aug. 6, 2026

(54) METHODS AND APPARATUS FOR MAKING GLASS VIALS USING LASERS

(71) Applicant: CORNING INCORPORATED, CORNING, NY (US)

(72) Inventors: Anatoli Anatolyevich Abramov, Painted Post, NY (US); Christopher Charles Chilson, Wellsboro, PA (US); Patrick Joseph Cimo, Corning, NY (US)

(21) Appl. No.: 19/151,212

(22) PCT Filed: Jan. 17, 2024
(86) PCT No.: PCT/US2024/011767

§ 371 Date: Jul. 25, 2025

Related U.S. Application Data
(60) Provisional application No. 63/441,305, filed on Jan. 26, 2023.
(60) Provisional application No. 63/523,780, filed on Jun. 28, 2023.

(51) Int. Cl. C03B 23/09

(52) U.S. Cl. CPC C03B 23/099

(57) ABSTRACT

A method for producing glass articles from glass tubes includes rotating a glass tube about a center axis, heating a target region of the glass tube to a forming temperature, forming at least one feature of the glass article at the target region of the glass tube, and separating the glass article from the working end of the glass tube. Heating the target region of the glass tube, separating the glass article from the working end of the glass tube, or both includes exposing the target region, a separating region, or both of the glass tube to a laser beam produced by a laser system, which heats the glass tube at the target region, the separating region, or both. A system includes the converter and the laser system for heating or separating the glass article from the glass tube.

### CROSS-REFERENCE TO RELATED APPLICATIONS

This application claims the benefit of priority under 35 U.S.C. § 119 of U.S. Provisional Application Ser. No. 63/441,305 filed on Jan. 26, 2023, and 63/523,780 filed on Jun. 28, 2023, the contents of which are relied upon and incorporated herein by reference in their entireties.

### BACKGROUND

### Field

The present specification generally relates to methods, apparatuses, and systems for glass articles, in particular, to methods, apparatuses, and systems for converting glass tubes to the glass articles in a converting process.

### Technical Background

Historically, glass has been used to produce a variety of articles. In particular, because of its hermeticity, optical clarity, and excellent chemical durability relative to other materials, glass has been a preferred material for pharmaceutical applications, including, without limitation, vacutainers, cartridges, syringes, syringe barrels, ampoules, bottles, flasks, vials, tubes, beakers, jars, and other glass articles. Production of these articles from glass starts with providing glass tubing that may subsequently be formed and separated into a plurality of the glass articles. Specifically, the glass used in pharmaceutical packaging must have adequate mechanical and chemical durability so as to not affect the stability of the pharmaceutical formulations contained therein. Glasses having suitable chemical durability include those glass compositions within the ASTM standard ‘Type IA’ and ‘Type IB’ glass compositions which have a proven history of chemical durability.

The glass tubes used as the starting material for producing glass articles are produced from a continuous process, such as a Danner or Vello process, for producing a continuous hollow glass cylinder. Glass tubing may be converted into other glass articles, such as various glass containers for use in pharmaceutical applications including, without limitation, vacutainers, cartridges, syringes, syringe barrels, ampoules, bottles, flasks, vials, tubes, beakers, jars, and other glass articles. The glass tubing may be converted, for example, in “converting machines.” Converting machines have been used for over 75 years, and are currently made by various commercial and internal equipment suppliers. These converting machines typically reform long lengths of glass tube into a plurality of glass articles using steps that include flame working, rotating and stationary tool forming, thermal separation, or score and shock cutoff steps. Various burners and forming tools are often used to shape one or more articles from the glass tube and separate the article from the glass tube.

### SUMMARY

Accordingly, an ongoing need exists for methods, apparatuses, and systems for converting glass tubes to glass articles using laser systems to heat the glass tubes prior to forming, separation of the glass articles from the glass tubes, or both. According to a first aspect of the present disclosure, a method for producing glass articles from glass tubes may comprise rotating a glass tube about a center axis of the glass tube; while rotating the glass tube, heating a target region of the glass tube to a forming temperature, wherein the target region may be proximate a working end of the glass tube; after heating the target region of the glass tube, forming at least one feature of the glass article at the target region of the glass tube, while rotating the glass tube; and separating the glass article from the working end of the glass tube at a separating region of the glass tube. Heating the target region of the glass tube, separating the glass article from the working end of the glass tube, or both may comprise exposing the target region, the separating region, or both of the glass tube with a laser beam having a largest cross-sectional dimension at the point where the laser beam is incident on the glass tube of from about 0.5 to about 1.25 times an outer diameter of the glass tube. Exposing the target region, the separating region, or both to the laser beam may heat the glass tube at the target region, the separating region, or both to a temperature of greater than or equal to 1000° C.

A second aspect of the present disclosure may include the first aspect, wherein heating the target region of the glass tube may comprise exposing the target region to the laser beam in a heating station of a converter for forming the glass articles from the glass tubes, wherein the laser beam may be a heating laser beam.

A third aspect of the present disclosure may include the second aspect, wherein the heating laser beam has a circular cross section.

A fourth aspect of the present disclosure may include any one of the first through third aspects, wherein separating the glass article from the working end of the glass tube may comprise exposing the separating region of the glass tube to the laser beam in a separating station of a converter for forming the glass articles from the glass tubes, wherein the laser beam may be a separating laser beam.

A fifth aspect of the present disclosure may include the fourth aspect, comprising exposing the separating region of the glass tube to a preheating laser beam in a heating station before translating the glass tube into the separating station.

A sixth aspect of the present disclosure may include either one of the fourth or fifth aspects, wherein the separating laser beam may have an elliptical cross section with a major axis and a minor axis.

A seventh aspect of the present disclosure may include any one of the fourth through sixth aspects, wherein the separating laser beam may have a beam length of from 5 mm to 50 mm at a point where the separating laser beam is incident on the glass tube.

An eighth aspect of the present disclosure may include any one of the fourth through seventh aspects, wherein separating the glass article from the working end of the glass tube may further comprise forming an open end on a bottom of the glass article, where the bottom of the glass article is the end of the glass article previously coupled to the glass tube prior to separation.

A ninth aspect of the present disclosure may include the eighth aspect, wherein the separating laser beam may have a beam width of from about 0.5 mm to about 5 mm at a point where the separating laser beam is incident on the glass tube.

A tenth aspect of the present disclosure may include either one of the eighth or ninth aspects, wherein the separating laser beam may be an elliptical beam having a ratio of major axis to minor axis of from about 4 to about 70 at a point where the separating laser beam is incident on the glass tube.

An eleventh aspect of the present disclosure may include any one of the fourth through seventh aspects, wherein separating the glass article from the working end of the glass tube may further comprise forming a bottom of the glass article while separating the glass article from the working end of the glass tube.

A twelfth aspect of the present disclosure may include the eleventh aspect, wherein the separating laser beam may have a beam width of from about 3 mm to about 10 mm at a point where the separating laser beam is incident on the glass tube.

A thirteenth aspect of the present disclosure may include either one of the eleventh or twelfth aspects, wherein the separating laser beam may be an elliptical beam having a ratio of major axis to minor axis of from about 2 to about 12 at a point where the separating laser beam is incident on the glass tube.

A fourteenth aspect of the present disclosure may include any one of the eleventh through thirteenth aspects, wherein the separating laser beam may be an elliptical beam and the major axis is oriented parallel to or perpendicular to the center axis of the glass tube.

A fifteenth aspect of the present disclosure may include any one of the eleventh through fourteenth aspects, further comprising decreasing a thickness of the bottom of the glass article. The separating laser beam may be an elliptical beam and decreasing the thickness of the bottom of the glass article may comprise one or more of orienting the separating laser beam with a major axis of the separating laser beam perpendicular to the center axis of the glass tube, decreasing a beam width of the separating laser beam, or a combination thereof.

A sixteenth aspect of the present disclosure may include the fifteenth aspect, wherein the separating laser beam may have a beam width of from about 5 mm to about 10 mm, or the separating laser beam may have a ratio of a major axis to a minor axis of from about 2 to about 7 at a point where the separating laser beam is incident on the glass tube.

A seventeenth aspect of the present disclosure may include any one of the eleventh through fourteenth aspects, comprising increasing a thickness of the bottom of the glass article. The separating laser beam may be an elliptical beam and increasing the thickness of the bottom of the glass article may comprise one or more of orienting the separating laser beam with a major axis of the separating laser beam parallel to the center axis of the glass tube, increasing a beam width of the separating laser beam, or a combination thereof.

An eighteenth aspect of the present disclosure may include the seventeenth aspect, wherein the separating laser beam may have a beam width of from about 3 mm to about 7 mm, or the separating laser beam may have a ratio of major axis to minor axis of from about 2.5 to about 12 at a point where the separating laser beam is incident on the glass tube.

A nineteenth aspect of the present disclosure may include any one of the eleventh through eighteenth aspects, wherein separating the glass article from the working end of the glass tube may comprise exposing the separating region of the glass tube to a separating laser beam having an elliptical cross-section and exposing the separating region of the glass tube to a preheating laser beam having a circular cross-section in the separating station.

A twentieth aspect of the present disclosure may include the nineteenth aspect, comprising superimposing the separating laser beam and the preheating laser beam on the separating region of the glass tube.

A twenty-first aspect of the present disclosure may include either one of the nineteenth or twentieth aspects, wherein a center of the separating laser beam may be offset in an axial direction relative to a center of the preheating laser beam, wherein the axial direction is a direction parallel to the center axis of the glass tube.

A twenty-second aspect of the present disclosure may include any one of the nineteenth through twenty-first aspects, further comprising modifying an axial position of the separating laser beam relative to an axial position of the preheating laser beam.

A twenty-third aspect of the present disclosure may include the twenty-second aspect, further comprising moving a center of the separating laser beam toward the working end of the glass tube relative to a center of the preheating laser beam, wherein moving the center of the separating laser beam closer to the working end of the glass tube relative to the center of the preheating laser beam may increase a flatness of the bottom of the glass article and may decrease a corner radius at a transition between the bottom and a sidewall of the glass article.

A twenty-fourth aspect of the present disclosure may include any one of the fourth through twenty-third aspects, further comprising exposing the separating region of the glass tube to a burner in a heating station before translating the glass tube into the separating station.

A twenty-fifth aspect of the present disclosure may include any one of the fourth through twenty-fourth aspects, wherein separating the glass article from the working end of the glass tube may comprise exposing the separating region of the glass tube to the separating laser beam having an elliptical cross-section and exposing the separating region of the glass tube to burner in the separating station, wherein the burner preheats the glass tube.

A twenty-sixth aspect of the present disclosure may include any one of the fourth through twenty-fifth aspect, wherein separating the glass article from the working end of the glass tube may comprise applying a pulling force to the glass article while exposing the separating region of the glass tube to the laser beam, wherein the pulling force may move the glass article away from the glass tube in an axial direction.

A twenty-seventh aspect of the present disclosure may include the twenty-sixth aspect, wherein the glass tube may be oriented vertically with the working end of the glass tube facing downward, and the pulling force may include the force of gravity.

A twenty-eighth aspect of the present disclosure may include either one of the twenty-sixth or twenty-seventh aspects, wherein applying the pulling force may comprise mechanically pulling the glass article in a direction axially away from the glass tube.

A twenty-ninth aspect of the present disclosure may include any one of the first through twenty-eighth aspects, wherein heating the target region of the glass tube, separating the glass article from the working end of the glass tube, or both may comprise exposing the target region, the separating region, or both of the glass tube with a first laser beam and, at the same time, exposing the target region, the separating region, or both of the glass tube with a second laser beam, wherein the first laser beam and the second laser beam are incident on the target region or the separating region of the glass tube.

A thirtieth aspect of the present disclosure may include the twenty-ninth aspect, wherein the first laser beam and the second laser beam may be superimposed on the glass tube.

A thirty-first aspect of the present disclosure may include either one of the twenty-ninth or thirtieth aspects, further comprising modifying an axial position of the second laser beam relative to an axial position of the first laser beam.

A thirty-second aspect of the present disclosure may include any one of the twenty-ninth through thirty-first aspects, wherein the first laser beam may have a circular beam cross-section, and the second laser beam may have an elliptical beam cross-section.

A thirty-third aspect of the present disclosure may include any one of the first through thirty-second aspects, wherein forming may comprise contacting a surface of the glass tube in the target region with one or more forming tools while rotating the glass tube, wherein contact between the forming tools and the surface of the glass tube changes a shape of the glass tube in the target region.

A thirty-fourth aspect of the present disclosure may include any one of the first through thirty-third aspects, further comprising operating a converter to produce a plurality of glass articles from a plurality of glass tubes, wherein the converter may comprise a plurality of processing stations comprising at least one heating station, at least one forming station, and a separating station; operating the converter may comprise translating each of the plurality of glass tubes through each of the plurality of processing stations in succession; and the at least one heating station, the at least one separating station, or both may comprise exposing each of the glass tubes to the laser beam to heat each of the glass tubes at the target region, the separating region, or both.

A thirty-fifth aspect of the present disclosure may include any one of the first through thirty-fourth aspects, further comprising securing a glass tube in a holder of a converter comprising a plurality of processing stations, the plurality of processing stations comprising at least one heating station, at least one forming station, and a separating station, wherein the converter translates the holder and the glass tube successively through each of the processing stations. The method may further include forming one or more features of a glass article at a working end of the glass tube by translating the glass tube through the at least one heating station and the at least one forming station and separating the glass article from the working end of the glass tube in the separating station. Heating the target region of the glass tube may comprise exposing the target region of the glass tube to the laser beam in the at least one heating station or separating the glass article from the working end of the glass tube may comprise exposing the separating region of the glass tube with the laser beam in the separating station.

A thirty-sixth aspect of the present disclosure may include any one of the first through thirty-fifth aspects, wherein the glass articles may be pharmaceutical containers. A thirty-seventh aspect of the present disclosure may include the thirty-sixth aspect, wherein the pharmaceutical containers may comprise vacutainers, cartridges, syringes, syringe barrels, ampoules, bottles, flasks, vials, tubes, beakers, or jars.

A thirty-seventh aspect of the present disclosure may be directed to a method for removing a glass article from a working end of a glass tube during converting. The method may comprise translating the working end of the glass tube into a separating station of a converter; rotating the glass tube about a center axis of the glass tube; while rotating the glass tube, exposing a separating region of the glass tube a laser beam; and applying an axial force to the glass article in a direction axially away from the glass tube. Exposing the separating region of the glass tube with the laser beam and applying the axial force to the glass article may separate the glass article from the working end of the glass tube.

A thirty-eighth aspect of the present disclosure may include the thirty-seventh aspect, comprising exposing the separating region of the glass tube to a preheating laser beam in a heating station before translating the glass tube into the separating station.

A thirty-ninth aspect of the present disclosure may include either one of the thirty-seventh or thirty-eighth aspects, wherein the separating laser beam may have an elliptical cross section with a major axis and a minor axis.

A fortieth aspect of the present disclosure may include any one of the thirty-seventh through thirty-ninth aspects, wherein the separating laser beam may have a beam length of from 5 mm to 50 mm at a point where the separating laser beam is incident on the glass tube.

A forty-first aspect of the present disclosure may include any one of the thirty-seventh through fortieth aspects, wherein separating the glass article from the working end of the glass tube may further comprise forming an open end on a bottom of the glass article where the bottom of the glass article is the end of the glass article previously coupled to the glass tube prior to separation.

A forty-second aspect of the present disclosure may include the forty-first aspect, wherein the separating laser beam may have a beam width of from about 0.5 mm to about 5 mm at a point where the separating laser beam is incident on the glass tube.

A forty-third aspect of the present disclosure may include either one of the forty-first or forty-second, wherein the separating laser beam may be an elliptical beam having a ratio of major axis to minor axis of from about 4 to about 70 at a point where the separating laser beam is incident on the glass tube.

A forty-fourth aspect of the present disclosure may include any one of the thirty-seventh through forty-third aspects, wherein separating the glass article from the working end of the glass tube further may comprise forming a bottom of the glass article while separating the glass article from the working end of the glass tube.

A forty-fifth aspect of the present disclosure may include the forty-fourth aspect, wherein the separating laser beam may have a beam width of from about 3 mm to about 10 mm at a point where the separating laser beam is incident on the glass tube.

A forty-sixth aspect of the present disclosure may include either one of the forty-fourth or forty-fifth aspects, wherein the separating laser beam may be an elliptical beam having a ratio of major axis to minor axis of from about 2 to about 12 at a point where the separating laser beam is incident on the glass tube.

A forty-seventh aspect of the present disclosure may include any one of the forty-fourth through forty-sixth aspects, wherein the separating laser beam may be an elliptical beam and the major axis may be parallel to or perpendicular to the center axis of the glass tube.

A forty-eighth aspect of the present disclosure may include any one of the forty-fourth through forty-seventh aspects, further comprising decreasing a thickness of the bottom of the glass article, wherein the separating laser beam may be an elliptical beam and decreasing the thickness of the bottom of the glass article may comprise one or more of orienting the separating laser beam with a major axis of the separating laser beam perpendicular to the center axis of the glass tube, decreasing a beam width of the separating laser beam, or a combination thereof.

A forty-ninth aspect of the present disclosure may include the forty-eighth aspect, wherein the separating laser beam may have a beam width of from about 5 mm to about 10 mm, or the separating laser beam may have a ratio of a major axis to a minor axis of from about 2 to about 7 at a point where the separating laser beam is incident on the glass tube.

A fiftieth aspect of the present disclosure may include any one of the forty-fourth through forty-ninth aspects, comprising increasing a thickness of the bottom of the glass article, wherein the separating laser beam may be an elliptical beam and increasing the thickness of the bottom of the glass article comprises one or more of orienting the separating laser beam with a major axis of the separating laser beam parallel to the center axis of the glass tube; increasing a beam width of the separating laser beam; or a combination thereof.

A fifty-first aspect of the present disclosure may include the fiftieth aspect, wherein the separating laser beam may have a beam width of from about 3 mm to about 7 mm, or the separating laser beam may have a ratio of major axis to minor axis of from about 2.5 to about 12 at a point where the separating laser beam is incident on the glass tube.

A fifty-second aspect of the present disclosure may include any one of the forty-fourth through fifty-first aspects, wherein separating the glass article from the working end of the glass tube may comprise exposing the separating region of the glass tube to a separating laser beam having an elliptical cross-section and exposing the separating region of the glass tube to a preheating laser beam having a circular cross-section.

A fifty-third aspect of the present disclosure may include the fifty-second aspect, comprising superimposing the separating laser beam and the preheating laser beam on the separating region of the glass tube.

A fifty-fourth aspect of the present disclosure may include either one of the fifty-second or fifty-third aspects, wherein a center of the separating laser beam may be offset in an axial direction relative to a center of the preheating laser beam, wherein the axial direction is a direction parallel to the center axis of the glass tube.

A fifty-fifth aspect of the present disclosure may include any one of the fifty-second through fifty-fourth aspects, further comprising modifying an axial position of the separating laser beam relative to an axial position of the preheating laser beam.

A fifty-sixth aspect of the present disclosure may include any one of the fifty-second through fifty-fifth aspects, further comprising moving a center of the separating laser beam toward the working end of the glass tube relative to a center of the preheating laser beam, wherein moving the center of the separating laser beam closer to the working of the glass tube relative to the center of the preheating laser beam may increase a flatness of the bottom of the glass article and may decrease a corner radius at a transition between the bottom and a sidewall of the glass article.

A fifty-seventh aspect of the present disclosure may include any one of the first through fifty-sixth aspects, wherein exposing the target region or the separating region of the glass tube to the laser beam may comprise producing the laser beam using a laser source; passing the laser beam through optics that modify a shape or power density distribution of the laser beam; and directing the laser beam towards the target region or separating region of the glass tubes.

A fifty-eighth aspect of the present disclosure may include any one of the first through fifty-seventh aspects, wherein the laser beam may be a continuous laser beam or a pulsed laser beam.

A fifty-ninth aspect of the present disclosure may include any one of the first through fifty-eighth aspects, wherein the laser beam may be collimated or un-collimated laser beam.

A sixtieth aspect of the present disclosure may include any one of the first through fifty-ninth aspects, wherein the laser beam may have a laser power of from 50 W to 2000 W.

A sixty-first aspect of the present disclosure may include any one of the first through sixtieth aspects, wherein the laser beam may be an elliptical beam or a round beam.

A sixty-second aspect of the present disclosure may include any one of the first through sixty-first aspects, wherein the laser beam may have a wavelength in a range of from about 1 μm to about 12 μm, or from about 5 μm to about 11 μm.

A sixty-third aspect of the present disclosure may include any one of the first through sixty-second aspects, further comprising changing a shape of the laser beam, wherein changing the shape of the laser beam may change a volume of glass heated in the target region or the separating region of the glass tube.

A sixty-fourth aspect of the present disclosure may include any one of the first through sixty-third aspects, further comprising changing a power density of the laser beam, wherein changing the power density may change the heating rate of the laser beam.

A sixty-fifth aspect of the present disclosure may include any one of the first through sixty-fourth aspects, further comprising controlling an exposure time of the glass tube to the laser beam during heating the target region of the glass tube, separating the glass article from the working end of the glass tube or both by adjusting times at which a laser source for producing the laser beam is turned on and turned off.

A sixty-sixth aspect of the present disclosure may include any one of the first through sixty-fifth aspects, comprising rotating the glass tubes at a rotational speed of from 60 rpm to 400 rpm.

A sixty-seventh aspect of the present disclosure may include any one of the first through sixty-sixth aspects, wherein the laser beam may have a heating rate of up to 400° C./second.

A sixty-eighth aspect of the present disclosure may include any one of the first through sixty-seventh aspects, wherein a converting rate of converting glass tubes to the glass articles may be greater than or equal to 30 parts per minute or wherein the converting process may not be rate limited by the separating the glass article from the glass tube.

A sixty-ninth aspect of the present disclosure may be directed to a system for producing glass articles from glass tubes. The system may comprise a converter comprising a plurality of processing stations spaced apart in a circuit and at least one holder. The plurality of processing stations may comprise at least one heating station, at least one forming station, and a separating station. The at least one holder may be operable to hold a glass tube with a working end of the glass tube oriented towards the plurality of processing stations and to rotate the glass tube about a center axis of the glass tube. The converter may be operable to translate the at least one holder having the glass tube secured therein through each of the plurality of processing stations in succession. The system may further include a laser system disposed in the at least one heating station or the separating station. The laser system may comprise a laser source and a beam delivery system. The laser system may be operable to generate a laser beam, modify one or more properties of the laser beam, and direct the laser beam at the glass tube when the glass tube is in the at least one heating station or the separating station.

A seventieth aspect of the present disclosure may include the sixty-ninth aspect, wherein the at least one laser system may comprise a plurality of laser systems, wherein the plurality of laser systems may comprise at least one heating laser system disposed in the at least one heating station and a separating laser system disposed in the separating station.

A seventy-first aspect of the present disclosure may include either one of the sixty-ninth or seventieth aspects, wherein the laser system may comprise a laser source and a beam delivery system, the laser system may be operable to produce the laser beam having a wavelength of from 1 μm to 12 μm and a power density of from 50 W to 2000 W, and the beam delivery system may be operable to modify a cross-sectional shape of the laser beam and direct the laser beam at the separating region of the glass tube in the separating station.

A seventy-second aspect of the present disclosure may include the seventy-first aspect, wherein the laser source may comprise a CO laser, a CO2 laser, or a quantum cascade laser.

A seventy-third aspect of the present disclosure may include either one of the seventy-first or seventy-second aspects, wherein the beam delivery system may comprise at least one optical component selected from lenses, mirrors, prisms, filters, apertures, or combinations of these.

A seventy-fourth aspect of the present disclosure may include any one of the seventy-first through seventy-third aspects, wherein the laser system further may comprise at least one turning mirror.

A seventy-fifth aspect of the present disclosure may include the seventy-fourth aspect, wherein the laser system may be disposed at a position where the laser beam does not have a straight path to the glass tube in at least one heating station or the separating station, and the at least one turning mirror may be positioned to change the beam path of the laser beam so that the laser beam is incident on the target region or separating region of the glass tube.

A seventy-sixth aspect of the present disclosure may include any one of the sixty-ninth through seventy-fifth aspects, further comprising a laser system positioner coupled to the laser system, wherein the laser system positioner may be operable to position the laser system relative to the glass tube in the at least one heating station or the separating station.

A seventy-seventh aspect of the present disclosure may include any one of the sixty-ninth through seventy-sixth aspects, wherein the laser system may be disposed in the at least one heating station of the converter.

A seventy-eighth aspect of the present disclosure may include the seventy-seventh aspect, wherein the laser system may be operable to produce the laser beam having a circular cross-section and to direct the laser beam at the glass tube in the at least one heating station.

A seventy-ninth aspect of the present disclosure may include any one of the sixty-ninth through seventy-eighth aspects, wherein the laser system may be disposed in the separating station.

An eightieth aspect of the present disclosure may include the seventy-ninth aspect, wherein the laser system may be operable to produce the laser beam having an elliptical cross-section.

An eighty-first aspect of the present disclosure may include either one of the seventy-ninth or eightieth aspects, wherein the laser system may comprise a separating laser system operable to produce a separating laser beam having an elliptical cross-sectional shape, and a preheating laser system operable to produce a preheating laser beam having a circular cross-sectional shape.

An eighty-second aspect of the present disclosure may include the eighty-first aspect, wherein the laser system may be operable to superimpose the separating laser beam and the preheating laser beam on a separating region of the glass tube.

An eighty-third aspect of the present disclosure may include any one of the seventy-ninth through eighty-second aspects, further comprising a burner in the separating station, wherein the burner may be spaced apart from the laser beam in an angular direction relative to a center axis of the glass tube, and the burner may be operable to preheat the separating region of the glass tube while the laser beam is directed at the separating region of the glass tube.

An eighty-fourth aspect of the present disclosure may include any one of the seventy-ninth through eighty-third aspects, further comprising a heating station directly upstream of the separating station, wherein the heating station may comprise a preheating laser system operable to produce a preheating laser beam and directing the preheating laser beam at a separating region of the glass tube.

An eighty-fifth aspect of the present disclosure may include the eighty-fourth aspect, wherein the heating station further may comprise a burner operable to further heat the separating region of the glass tube.

An eighty-sixth aspect of the present disclosure may include any one of the seventy-ninth through eighty-fifth aspects, further comprising a heating station directly upstream of the separating station, wherein the heating station may comprise a burner operable to heat the separating region of the glass tube before translating the glass tube to the separating station.

Additional features and advantages of the systems and methods disclosed herein will be set forth in the detailed description, which follows, and in part will be readily apparent to those skilled in the art from that description or recognized by practicing the embodiments described herein, including the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a system comprising a converter for converting glass tubes to a plurality of glass articles, according to one or more embodiments shown and described herein;

FIG. 2 schematically depicts a glass tube, according to one or more embodiments shown and described herein;

FIG. 3 schematically depicts a top view of the converter of FIG. 1 illustrating a layout of processing stations; according to one or more embodiments shown and described herein;

FIG. 4 schematically depicts a heating station of the converter of FIG. 1, according to one or more embodiments shown and described herein;

FIG. 5 schematically depicts a forming station of the converter of FIG. 1, according to one or more embodiments shown and described herein;

FIG. 6 schematically depicts another embodiment of a forming station of the converter of FIG. 1, according to one or more embodiments shown and described herein;

FIG. 7 schematically depicts a separating station for a converter, the separating station comprising a gas burner, according to the prior art;

FIG. 8 schematically depicts a separating station for a converter, where the separating station comprises a laser system, according to one or more embodiments shown and described herein;

FIG. 9 graphically depicts relative beam intensity (y-axis) as a function of beam position (x-axis) for elongated beams having Gaussian and flat-top power density profiles, according to one or more embodiments shown and described herein;

FIG. 10 schematically depicts a top view of the system of FIG. 1 comprising the converter and a laser system, according to one or more embodiments shown and described herein;

FIG. 11 schematically depicts a beam shape of a round-shaped heating laser beam incident on a glass tube, according to one or more embodiments shown and described herein;

FIG. 12 schematically depicts a beam shape of an elliptical-shaped separating laser beam incident on a glass tube, according to one or more embodiments shown and described herein;

FIG. 13 schematically depicts a beam shape of an elliptical-shaped separating laser beam having a greater ratio of major axis to minor axis incident on a glass tube, according to one or more embodiments shown and described herein;

FIG. 14 schematically depicts a beam shape of an elliptical-shaped separating laser beam incident on a glass tube, where a major axis of the separating laser beam is parallel to a center axis of the glass tube, according to one or more embodiments shown and described herein;

FIG. 15 schematically depicts a beam shape incident on a glass tube resulting from superposition of a round-shaped heating laser beam and an elliptical-shaped separating laser beam, according to one or more embodiments shown and described herein;

FIG. 16 schematically depicts a separating station comprising a preheating laser system and a separating laser system configured to superimpose the preheating laser beam and the separating laser beam on a glass tube, according to one or more embodiments shown and described herein;

FIG. 17 schematically depicts a top view of a separating station comprising a preheating laser system and a separating laser system that are positioned to direct a preheating laser beam and a separating beam at a separating region of the glass tube without superimposing the two beams, according to one or more embodiments shown and described herein;

FIG. 18 schematically depicts a front view of the separating station of FIG. 16 where the separating laser beam is axially offset from the preheating laser beam, according to one or more embodiments shown and described herein;

FIG. 19A schematically depicts a front view of a separating station comprising a separating laser beam and a gas burner, according to one or more embodiments shown and described herein;

FIG. 19B schematically depicts a top view of the separating station of FIG. 19A, according to one or more embodiments shown and described herein;

FIG. 20 schematically depicts a front view of a glass article comprising a glass vial, according to one or more embodiments shown and described herein;

FIG. 21 schematically depicts a side view of a heating station comprising a laser system, according to one or more embodiments shown and described herein;

FIG. 22 schematically depicts a top view of a converter comprising laser systems for the separating station and for heating stations upstream of the separating station, according to one or more embodiments shown and described herein;

FIG. 23 schematically depicts a top view of a converter comprising a hybrid preheating system comprising both burners and laser heating elements upstream of the separating station, according to one or more embodiments shown and described herein;

FIG. 24 graphically depicts glass temperature (y-axis) as a function of time (x-axis) for exposure of a glass tube in a processing station of a converter to elliptical-shaped laser beams having different laser powers, according to one or more embodiments shown and described herein;

FIG. 25 graphically depicts glass temperature (y-axis) as a function of time (x-axis) for exposure of a glass tube in a processing station of a converter to laser beams having the same laser power density but different beam shapes, according to one or more embodiments shown and described herein;

FIG. 26 is a photograph of an end of a glass article separated from a glass tube using a gas burner and an end of a glass article separated from a glass tube using a laser beam for heating, according to one or more embodiments shown and described herein;

FIG. 27 is a photograph of a side view of separation of a glass article from a glass tube using a laser beam, according to one or more embodiments shown and described herein; and

FIG. 28 is a photograph of finished ends of a glass tube and glass article separated by a laser beam to form open ends on the glass tube and glass article, according to one or more embodiments shown and described herein.

### DESCRIPTION

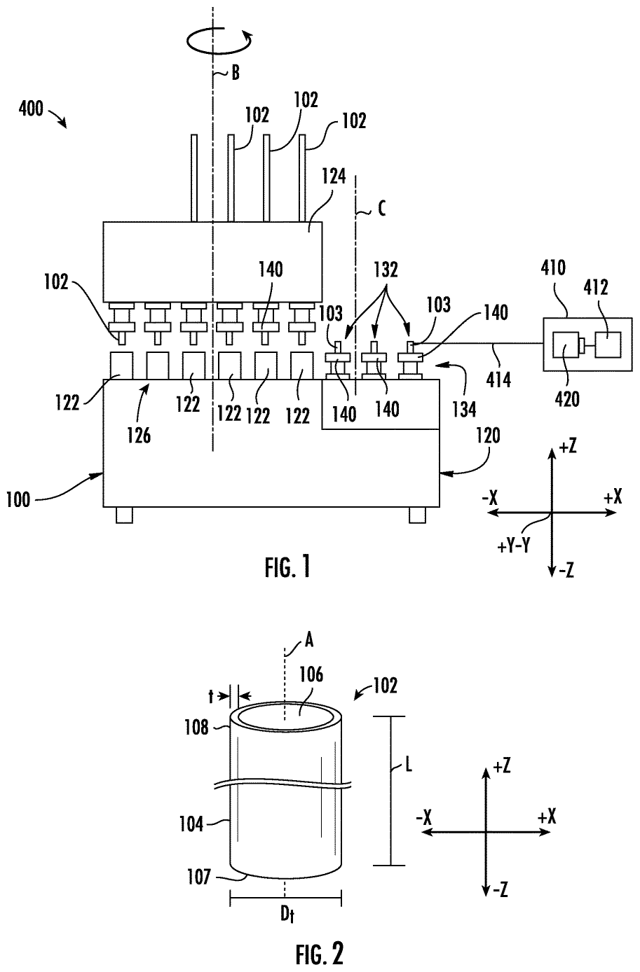

Reference will now be made in detail to embodiments of apparatuses, systems, and methods for producing glass articles from glass tubes using lasers, examples of which are illustrated in the accompanying drawings. Whenever possible, the same reference numerals will be used throughout the drawings to refer to the same or like parts. Referring now to FIG. 1, one embodiment of a system 400 for forming glass articles from glass tubes 102 is schematically depicted. The systems 400 disclosed herein may include a converter 100, which may comprise a plurality of processing stations 122 spaced apart in a circuit and at least one holder 140. The plurality of processing stations 122 may comprise at least one heating station, at least one forming station, and a separating station. The at least one holder 140 may be operable to hold a glass tube 102 with the working end 107 of the glass tube 102 oriented towards the plurality of processing stations 122 and to rotate the glass tube 102 about a center axis of the glass tube 102. The converter 100 may be operable to translate the at least one holder 140 having the glass tube 102 secured therein through each of the plurality of processing stations 122 in succession. The system 400 may further comprise a laser system 410 disposed in the at least one heating station or the separating station. The laser system 410 may comprise a laser source 412 and a beam delivery system 420. The laser system 410 may be operable to generate a laser beam 414, modify one or more properties of the laser beam 414, and direct the laser beam 414 at the glass tube 102 when the glass tube 102 in the at least one heating station or the separating station.

The system 400 may be employed in a method of producing glass articles from glass tubes 102. The method may comprise rotating the glass tube 102 about a center axis A of the glass tube 102; while rotating the glass tube 102, heating a target region of the glass tube 102 to a forming temperature, wherein the target region is proximate a working end of the glass tube 102; after heating the target region of the glass tube 102, forming at least one feature of the glass article at the target region of the glass tube 102, while rotating the glass tube 102; and separating the glass article 103 from the working end of the glass tube 102 at a separating region of the glass tube 102. Heating the target region of the glass tube 102, separating the glass article 103 from the working end of the glass tube 102, or both may comprise exposing the target region, the separating region, or both of the glass tube 102 with a laser beam 414 having a beam width of from about 0.5 mm to about 10 mm. Exposing the target region, the separating region, or both to the laser beam 414 may heat the glass at the target region, the separating region, or both to a temperature of greater than or equal to about 1000° C.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

Directional terms as used herein—for example up, down, right, left, front, back, top, bottom—are made only with reference to the figures as drawn and the coordinate axis provided therewith and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, “axial” refers to a direction parallel to the center axis A of the glass tube or glass rod.

As used herein, the “beam waist” of a laser beam refers to the point along the beam path of the laser beam at which point the power density of the laser beam is greatest.

As used herein, the term “circumference” of the glass tube refers to a collection of points of the glass tube at constant radius r from the center axis D of the glass tube at a particular Z position (i.e., position on the +/−Z axis of the figures) through 360 degrees. A circumference of the glass tube may coincide with an outer surface of the glass tube at a particular Z position or an inner surface of the glass tube at a specific Z position, for example.

As used herein, a “dwell time” of the converter refers to the duration of time that the glass tube spends in a particular processing station before passing to the next subsequent processing station.

As used herein, the term “active time” refers to a duration of time that the glass tube is maintained in engagement with at least one heating element or at least one forming tool while in a particular processing station.

As used herein, the term “index time,” when used in relation to an index converter, refers to a duration of time that it takes to index the glass tube from one processing station to the next processing station. The “dwell time,” “active time,” and “index time” are all measured in units of time.

When used in relation to a heating station, “engagement” of a laser beam with the glass tube refers to a condition in which the laser beam is incident on a surface of the glass tube. Conversely, when the laser beam is out of engagement with the glass tube, the laser beam is not incident on the glass tube, such as by turning off the laser beam, moving the laser beam away from the glass tube, or moving the glass tube out of the beam path of the laser beam.

As used herein, the term “part rate” refers to the production rate or throughput rate of the converter in units of number of glass articles per unit time.

As used herein, the terms “upstream” and “downstream” refer to the positions of processing stations and other components of the converter relative to a direction of travel of the glass tube through the converting process. For instance, a first processing station is “upstream” of a second processing station if the glass tube encounters the first processing station before encountering the second processing station. Conversely, the first processing station is “downstream” of the second processing station if the glass tube encounters the second processing station before encountering the first processing station.

As used herein, the terms “upbeam” and “downbeam” refer to the positioning of two or more features of a system relative to the direction of travel of a laser beam along a beam pathway through the system. A first component may be considered to be upbeam of a second component if the laser beam encounters the first component before encountering the second component. Conversely, a first component may be considered to be downbeam of a second component when the laser beam encounters the second component before encountering the first component.

As used herein, the “working end” of the glass tube is the end of the glass tube oriented towards the processing stations of the main turret of the converter relative to the holder, and the “non-working end” of the glass tube is the end of the glass tube oriented away from the processing stations of the main turret.

Because of its hermeticity, optical clarity, and excellent chemical durability relative to other materials, glass has been a preferred material for pharmaceutical applications, including, without limitation, vacutainers, cartridges, syringes, syringe barrels, ampoules, bottles, flasks, vials, tubes, beakers, jars, and other glass articles. These pharmaceutical glass containers, as well as other types of glass articles, can be produced through a process of converting a length of glass tube to one or more of the glass articles through a plurality of heating and forming operations.

Referring to FIG. 2, one embodiment of a glass tube 102 for use as the starting point for making a plurality of glass articles is schematically depicted. The glass tube 102 comprises an elongated hollow cylinder of glass having an outer surface 104 and an inner surface 106. The inner surface 106 defines an interior of the glass tube 102. The glass tubes 102 have a working end 107 and a non-working end opposite the working end 107. The working end 107 of the glass tube 102 is the end of the glass tube that is heated and formed into the glass articles, which are then separated from the glass tube 102 as will be described in further detail herein. The working end 107 of the glass tube 102 is the end of the glass tube 102 that is oriented in the −Z direction of the coordinate axis in FIG. 2 when the glass tube 102 is secured in the holder of the converter 100. The non-working end 108 of the glass tube 102 is the end opposite the working end 107 (i.e., the end of the glass tube 102 in the +Z direction of the coordinate axis of FIG. 2. The glass tubes 102 may have a circular cross-sectional shape and may be characterized by a tube length L, an outside diameter Dₜ, and a thickness t. The tube length L is the distance from the working end 107 to the non-working end 108, and the thickness t refers to the average radial distance between the outer surface 104 and the inner surface 106 of the glass tube 102. The glass tube 102 further comprises a center axis A.

The glass tubes 102 may be converted into glass articles, in particular glass articles for use in pharmaceutical applications, which may include, without limitation, vacutainers, cartridges, syringes, syringe barrels, ampoules, bottles, flasks, vials, tubes, beakers, jars, and other glass articles. The glass tubes 102 may be converted into these glass articles using a converter (i.e., a converting machine) comprising a plurality of processing stations. The processing stations may include but are not limited to heating stations, forming stations, a separating station, a piercing station, measuring stations, polishing stations, cooling stations, tube loading stations, or other types of processing stations. The converting machines typically reform long glass tube lengths into a plurality of glass articles using steps that include, but are not limited to, flame working, rotating and stationary tool forming, separating (e.g., thermal separation or score and shock cut-off steps), piercing, cooling, measuring, or other processing steps. Thus, glass articles produced through a converting process conducted on a converting machine are subjected to a series of flame burners or other heating elements and forming tools to shape the glass tube to specific shapes and dimensions and separate a formed glass article from the glass tube.

Referring now to FIG. 1, one embodiment of the system 400 for producing glass articles from a glass tube 102 is schematically depicted. The system 400 comprises a converter 100. The converter 100 may be used to convert glass tubes 102 into a plurality of glass articles. The converter 100 may include a base 120 having a plurality of processing stations 122 and a main turret 124 positioned above the base 120 and rotatable relative to the base 120 about the central axis B. The converter 100 may also include a plurality of secondary processing stations 132 on the base 120 and a secondary turret 134, which may be rotatable relative to the base 120.

As schematically depicted in FIG. 1, the base 120 of the converter 100 may be stationary and the processing stations 122 may be coupled to an upper portion 121 of the base 120. The processing stations 120 may be spaced apart from one another and arranged in a main circuit 126. In embodiments, the main circuit 126 may be circular so the main turret 124 may translate the glass tubes 102 through the plurality of processing stations 122 by rotation of the main turret 124. Alternatively, in embodiments, the main circuit 126 may be a linear arrangement of the processing stations 122. Although described herein in reference to a circular-shaped layout of processing stations 122, it is understood that the subject matter disclosed herein may apply equally well to converters having other arrangements of the processing stations 122, such as linear, curvilinear, or irregular-shaped arrangements of processing stations 122.

The type and/or shape of the glass articles to be made from the glass tube 102 may influence the total number of processing stations 122 of the converter 100. The number of processing stations 122 of the main circuit 126 may be from 14 to 50 processing stations 120. Although the converter 100 and converting process are described herein in the context of a converter 100 having sixteen processing stations 122 in the main circuit 126, it is understood that the converter 100 may have more or less than sixteen processing stations 122 in the main circuit 126. The processing stations 122 may include, by way of example and without limitation, one or more heating, forming, polishing, cooling, separating, piercing, measuring, feeding, discharge stations, other processing stations, or combinations of these for producing the glass articles from the glass tubes 102. The type and/or shape of the articles to be made from the glass tube 102 may also influence the type of processing stations 122 and/or order of processing stations 122 of the converter 100.

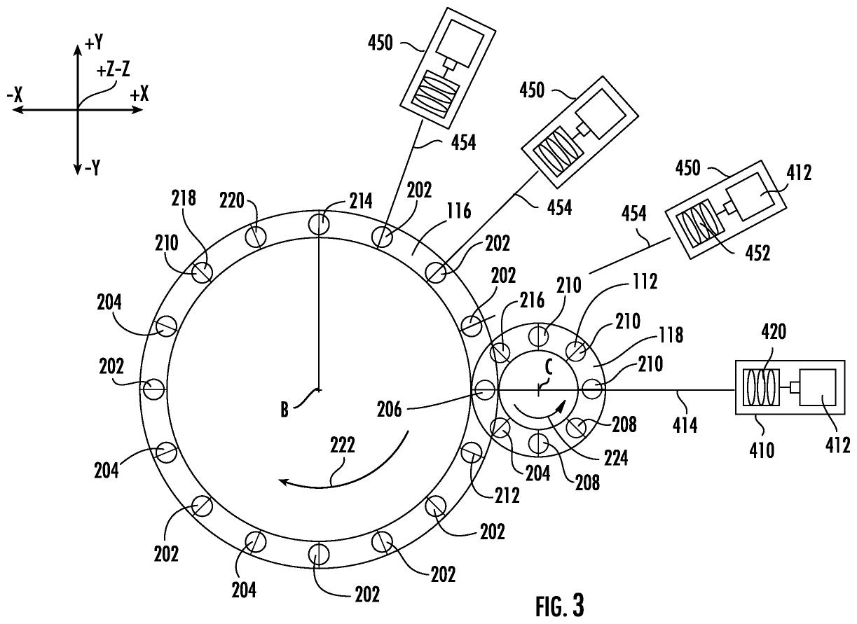

Referring to FIGS. 1 and 3, the converter 100 may include the secondary processing stations 132, which may be spaced apart from one another and arranged in a secondary circuit 136 (FIG. 3). In embodiments, the converter 100 may include the secondary turret 134 (FIG. 1) for indexing or continuously moving an article 103 (FIG. 1), which has been separated from the glass tube 102, through the plurality of secondary processing stations 132. The secondary turret 134 may be rotatable about a second axis C relative to the base 120. The secondary turret 134 may receive the glass articles 103 from a separating station 206 (FIG. 3) of the main turret 124, translate (e.g., index or continuously move) the articles 103 through the plurality of secondary processing stations 132 through rotation of the secondary turret 134, and discharge the finished articles from the converter 100. Although shown in a circular pattern, it is understood that the secondary processing stations 132 may be arranged in a linear, curvilinear, or irregular arrangement. In embodiments, the converter 100 may be configured to produce vials and the secondary processing stations 132 may be referred to as a bottom forming machine. For vials, the secondary processing stations 132 may be operable to form bottom of the vial.

The converter 100 may include a plurality of holders 140 configured to removably secure each glass tube 102 to the main turret 124. The holders 140 may be clamps, chucks, or other holding devices, or combinations of holding devices. The holders 140 may orient each glass tube 102 so that the glass tube 102 is generally parallel to the central axis B of the main turret 124 and generally perpendicular to the upper portion 121 of the base 120. Although the converter 100 is described in this specification in the context of a vertically oriented converter 100, it should be understood that the converter 100 may be oriented horizontally or at an angle such that the glass tube 102 is non-vertical during processing. Each holder 140 may be oriented to position the working end 107 of the glass tube 102 in each of the successive processing stations 122 as the main turret 124 rotates. Vertical orientation of the glass tubes 102 allows the working end 107 of each glass tube 102 to be moved or indexed progressively through the processing stations 122.

Each holder 140 may be individually rotatable relative to the main turret 124 to rotate the glass tube 102 about the center axis A of the glass tube 102. Each of the holders 140 may be operatively coupled to a motor (not shown), continuous drive belt, or other drive mechanism for active rotation of each of the holders 140. Rotation of the holders 140 allows for rotation of the glass tube 102 about center axis A of the glass tube 102 relative to stationary heating elements, forming tools, cooling nozzles, or other features of the processing stations 122. The heating element or forming tools in the processing stations 122 may be maintained in a fixed position relative to the glass tube 102, and the rotation of the glass tube 102 about center axis A may enable exposure of the entire circumference of the glass tube 102 to the heating elements or forming tools.

The converter 100 is operable to translate the glass tubes 102 through each of the processing stations 122 in succession. In embodiments, the converter 100 may be operable to index each of the plurality of holders 140 through the plurality of processing stations 122. Indexing may refer to the stepwise process of moving the glass tube 102 into a processing station 122, maintaining the glass tube 102 at a stationary position XYZ position in the processing station 122 for a dwell time, and then indexing the glass tube 102 to the next processing station 122. Alternatively, in embodiments, the converter 100 may be operable to translate the plurality of holders 140 continuously through the converting process. In embodiments, the processing stations 122 may translate with the glass tube 102 during the active time of the glass tube 102 in the processing stations 122.

Referring now to FIG. 3, as previously described, the plurality of processing stations 122 may include one or more heating stations 202, forming stations 204, separating stations 206, cooling stations 210, piercing stations 212, tube loading stations 214, discharge stations 216, measuring stations 218, tube length drop stations 220, or other stations and/or combinations of these stations. FIG. 3 schematically depicts one arrangement of the processing stations 122 for a converter 100 having a main circuit 126 of sixteen processing stations 122 and a secondary circuit 136 of eight secondary processing stations 132. As previously described, the processing stations 122 of the main circuit 126 may be evenly spaced apart and evenly distributed about a circular circuit, and the secondary processing stations 132 of the secondary circuit 136 may also be evenly spaced apart and evenly distributed about a circular circuit.

The main circuit 126 of the converter schematically depicted in FIG. 3 may include one or more heating stations 202, a separating station 206, a piercing station 212, one or more forming stations 204, one or more cooling stations 210, a measuring station 218, a tube length drop station 220, and a tube loading station 214. Although FIG. 3 depicts the main circuit 126 as having a circular arrangement of the processing stations 122, as previously discussed, the main circuit 126 may have the processing stations 122 positioned in other non-circular-shaped arrangements, such as linear, curvilinear, irregular-shaped, or other arrangements. With respect to the direction of rotation 222 of the main turret 124, the heating stations 202 may be positioned before each of the forming stations 204 and before the separating stations 206 to preheat target regions of the glass tube 102 to a viscosity at which the glass becomes deformable and may effectively be shaped or stretched and separated. At the separating station 206, the formed glass article 103 (FIG. 1) may be separated from the working end 107 of the glass tube 102 (FIG. 1) as its bottom is concurrently formed. The separating station 206 may also be the processing station 122 at which the partially formed glass article 103, once separated, is transferred to the secondary turret 134 (FIG. 1) to be indexed through the secondary circuit 136 of secondary processing stations 132. The piercing station 212 may be positioned on the main circuit 126 downstream of the separating station 206 in the direction of rotation 222 of the main turret 126. At the piercing station 212, a meniscus of glass at the working end 107 of the glass tube 102, which is formed in the separating station 206, is pierced, thereby reopening the working end 107 of the glass tube 102.

Referring again to FIG. 3, the forming stations 204 of the main turret 108 may be positioned downstream of the piercing station 212 and one or more heating stations 202 in the direction of rotation 222. The forming stations 204 may shape the glass tube 102 to form one or more features of the finished glass article. As noted above, one or more heating stations 202 may be positioned before each of the forming stations 204 to preheat target regions of the glass tube 102 to a temperature at which the glass tube 102 may be shaped and formed into the desired features. The forming stations 204 of the main turret 124 may shape the working end of the glass tube 102 to form features at one end of the glass articles 103, and the forming stations 204 of the secondary turret 134 may shape the other end of the glass articles 103 after the glass article 103 has been separated from the glass tube 102. In embodiments, the converter 100 may be used to produce vials from the glass tubes 102, and the forming stations 204 of the converter 100 may include one or more shoulder forming stations, flange forming stations, flange finishing stations, or combinations of these with one or more heating stations 202 positioned before and between each of the forming stations 204.

The main circuit 126 may further include a measuring station 218, at which at least one measurement device may be used to measure one or more attributes of the glass tube 102, such as the diameter and thickness for example, or one or more dimensions of the features of the glass article 103 formed by the forming stations 204. One or more cosmetic attributes of the glass tube 102 or glass article 103 may also be assessed in the measuring station 218. Still referring to FIG. 3, one or more cooling stations 210 may be positioned after the forming stations 204 in the direction of rotation 222 of the main turret 124. A tube length drop station 220 may be positioned after the forming stations 204, between the forming stations 204 and the separating station 206, to drop the partially formed glass tube 102 down, thereby positioning the glass tube 102 for separating the glass article 103 from the glass tube 102 at the separating station 206. The main circuit 126 may also include a tube loading station 214 for loading a new length of glass tube 102 feedstock from a glass tube loading turret (not shown) to the main turret 124.

Referring again to FIG. 3, once the glass article 103 is separated from the glass tube 102 at the separating station 206, the glass article 103 may be transferred to the secondary processing stations 132 of the secondary turret 134. The secondary processing stations 132 may include one or more forming stations 204 for forming a second end of the glass article 103, which is opposite the first end of the glass article 103. For example, the forming stations 204 of the secondary processing stations 112 may form one or more features at a bottom (second end) of the glass article 103. The secondary turret 134 may rotate about the axis C in a direction 224 that is opposite the direction of rotation 222 of the main turret 124. In embodiments, the secondary turret 134 may rotate in a direction that is the same as the main turret 124.

The secondary processing stations 132 of the secondary circuit 136 may include one or more heating stations 202, forming stations 204, polishing stations 208, cooling stations 210, discharge stations 216, or other stations or combinations of secondary processing stations 132. In embodiments, the secondary processing stations 132 of the secondary circuit 136 may be used to form one or more features of the glass article 103, such as a vial, ampoule, cartridge, or syringe, for example, at an end of the glass article 103 opposite the end formed by the main turret 124. For example, in embodiments, the glass article 103 is a vial and the forming stations 204 of the secondary circuit 136 may form the bottom of the vial. Other features are also contemplated such as those features characteristic of ampoules, cartridges, syringes, vacutainers, jars, and the like. The secondary circuit 136 may include one or more polishing stations 208 to finish the surface of the glass article. The secondary circuit 136 may further include a plurality of cooling stations 210 and the discharge station 216, at which station the finished glass article 103 may be discharged from the converter 100.

Referring again to FIGS. 1 and 3, in operation, the main turret 124 may index or move the glass tubes 102, which are secured in the holders 140, into a processing station 122. A specific operation, such as heating, forming, piercing, separating, cooling, dropping, feeding, measuring, etc. may be performed at each of the processing stations 122. The converter 100 may be tuned so that all of the processing stations 122 complete their operations within the dwell time. At the end of the dwell time, the main turret 124 may index the glass tubes 102 to the next processing stations 122 in the main circuit 126 during an index time. For an indexing converter, the total time per part per station, as used in this disclosure, is the sum of the dwell time and the index time.

In embodiments, the converter 100 may be a continuous converter operable to move the glass tubes 102 and holders 140 continuously through the plurality of processing stations 122. In embodiments, the heating elements, burners, forming tools, measurement devices, and other elements of the converting process may move with the glass tube 102 as it passes through the processing station 122. For both an indexing converter and a continuous converter, an “active time” of the processing station is a duration of time that the glass tube 102 is maintained in engagement with at least one heating element, at least one forming tool, at least one cooling nozzle, or other device while in the processing station 122.

The previous description of the processing stations 122 of the main circuit 126 and the secondary processing stations 132 of the secondary circuit 136 may represent a typical converter 100 for producing vials from the glass tube 102. However, it is understood that more or fewer processing stations 122 and secondary processing stations 132 may be utilized to make vials having different shapes or features or other glass articles, such as but not limited to vacutainers, cartridges, syringes, syringe barrels, ampoules, bottles, flasks, tubes, beakers, jars, and other glass articles or other pharmaceutical glass articles. Additionally, it is understood that the processing stations 122 and secondary processing stations 132 may be arranged in any of a number of different orders and/or configurations in order to produce differently shaped glass articles.

Examples of converters 100 for converting glass tube 102 into glass vials may include the Vial Forming Machine Models RP16 or RP18 with Automatic Tube Feeder manufactured by AMBEG Dr. J. Dichter GmbH, which includes sixteen processing stations 122 in the main circuit 126 and eight secondary processing stations 132. Other examples include the Vial Forming Machine Model RP32 manufactured by AMBEG Dr. J. Dichter GmbH, which has thirty-two processing stations 122 in the main circuit 126 and two secondary circuits 136 with eight secondary processing stations 132 in each secondary circuit 136, and the Zeta 098 Vial Forming Machine manufactured by Euromatic S.R.L., which has 36 processing stations. Another example may include the Zeta 103 Cartridge Forming Machine manufactured by Euromatic S.R.L., which is a converter for converting glass tube into glass cartridges. The cartridge converter has similar characteristics to the previously described vial converters 100 but is utilized to produce glass articles having a cartridge form factor rather than a vial. Converters for forming syringes, jars, ampoules, vacutainers, or other glass pharmaceutical containers may also be used.

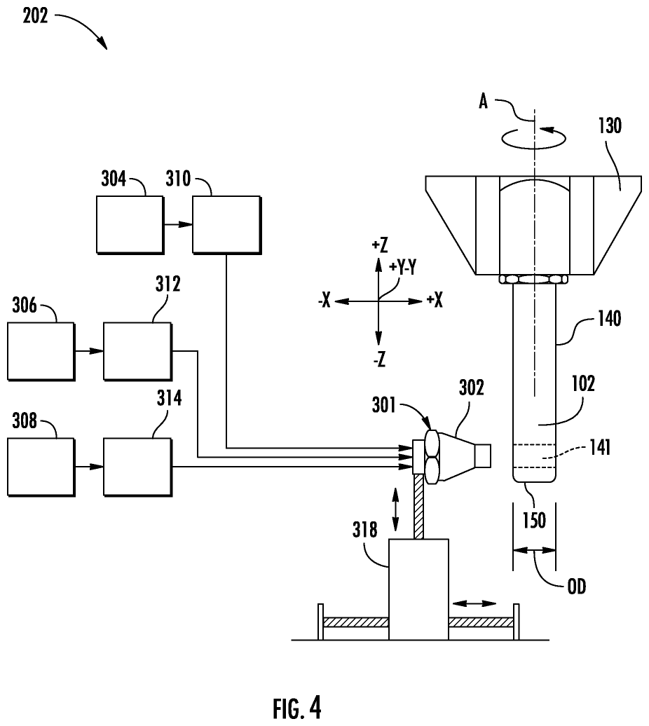

Referring now to FIG. 4, a heating station 202 of the converter 100 is schematically depicted. Each of the heating stations 202 may include one or more heating elements 301. As illustrated in FIG. 3, in a typically converter 100, the heating element 301 may include one or more burners 302, which are used to heat targeted regions of the glass tube 102 prior to a forming operation performed at the forming station 204 (FIG. 3) or separating operation performed at the separating station 206 (FIG. 3). Although FIG. 4 depicts a single burner 302, it is understood that a plurality of burners 302 may be employed in a single heating station 202. Each burner 302 may be fluidly coupled to a fuel gas supply 304, an oxygen supply 306, and, optionally, an air supply 308. Examples of fuel gases for the burner 302 may include, but are not limited to hydrogen, hydrocarbon fuel gases such as methane, propane, and butane for example, other fuel gases, or combinations of these.

Each burner 302 may include a fuel control valve 310 to control the flow rate of fuel gas to the burner 302. Each burner 302 may also include an oxygen control valve 312 to control the mass flow rate of oxygen to the burner 302. Each burner 302 may further include an air control valve 314 for optionally controlling a flow rate of air to the burner 302. The burner 302 combusts the fuel gas in the presence of oxygen and/or air to produce a flame that heats at least the target region of the glass tube 102.

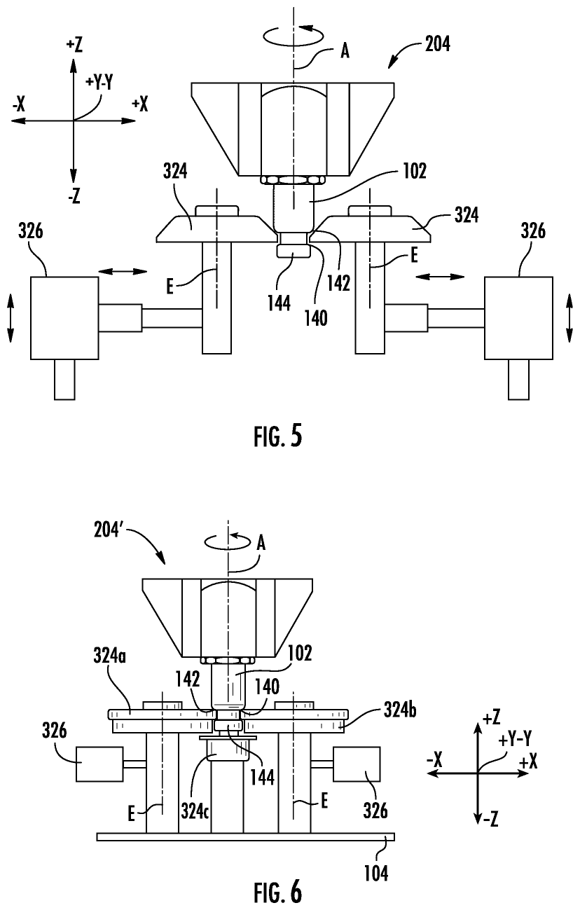

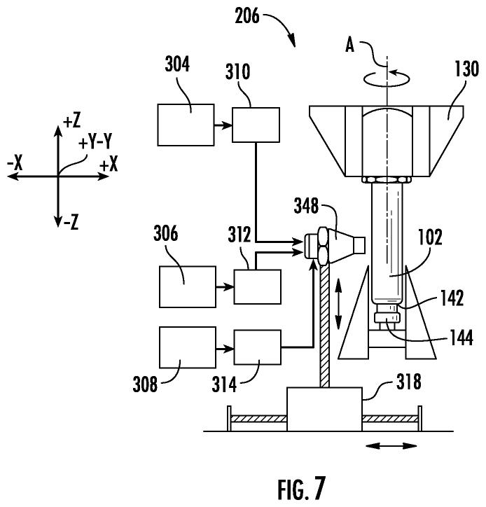

Referring now to FIGS. 5 and 6, examples of forming stations 204 of the converter 100 are schematically depicted. Each forming station 204 may include one or more forming tools 324 rotatable relative to the base 120 (FIG. 1) about tooling axis E. When passed into the forming station 204, the glass tube 102, which has been heated in a prior heating station 202, is rotated by the holder 140. The forming tools 324 may engage with the glass tube 102 as it rotates. When engaged, contact of the forming tools 324 with the heated glass tube 102 may form the glass tube 102 into the desired shape. The forming tools 324 may be contacted with the glass tube 102 for an active time of the forming tools 324. At the end of the active time, the forming tool actuators 326 may withdraw the forming tools 324 from engagement with the glass tube 102. FIG. 5 schematically illustrates an embodiment of a forming station 204 for forming the shoulder 142 of a glass vial. FIG. 6 schematically depicts an exemplary embodiment of a forming station 204′ for forming the flange 144 of a glass vial. The forming station 204′ for forming the flange 144 comprises three forming tools 324a, 324b, and 324c. Other types of forming tools 324 may be employed in the forming station 204 depending on the desired features of the glass article 103.

Referring again to FIG. 5, the forming tool actuators 326 may be operable to move the forming tools 324 into and out of engagement with the glass tube 102. Moving the forming tools 324 into and out of engagement with the glass tube 102 may control the contact timing of the forming tools 324 with the glass tube 102. The contact timing of the forming tools 324 with the glass tube 102 refers to the timing of engaging and disengaging each of the forming tools 324 in a forming station 204 with the glass tube 102. Adjusting the contact timing of the forming tools 324 may adjust the total contact time of each of the forming tools 324 in contact with the glass tube 102. The contact time refers to the duration of time that the forming tools 324 are engaged or in contact with the glass tube 102. The forming tool actuators 326 may further be operable to change the position of the forming tools 324 vertically (e.g., in the +/−Z direction of the coordinate axis in FIG. 3), horizontally (e.g., in the X-Y plane identified by the coordinate axis in FIG. 4), or a combination of these directions relative to the glass tube 102 in the forming station 204.

Referring now to FIG. 7, a conventional separating station 206 of the converter 100 is schematically depicted. The conventional separating station 206 depicted in FIG. 7 is a thermal separation station and is positioned after one or more heating stations 202 in the direction of rotation 222 of the main turret 124. The heating stations 202 positioned before the separating station 206 preheat the glass tube 102. The conventional separating station 206 has at least one separating burner 348. The separating burner 348 may have any of the features previously described for burners 302, including but not limited to a fuel gas control valve 310, an oxygen control valve 312, and/or an air control valve 314. While the glass tube 102, which has been made viscously deformable by the previous heating stations 202, is rotated by the holder 140 about the center axis A of the glass tube 102, the separating burner 348 engages with the outer surface 140 of the glass tube 102 to heat the glass tube 102 to a temperature at which the viscosity of the glass causes the partially formed glass article to separate from the glass tube 102. Once separated from the glass tube 102, the partially formed article may be transferred to the secondary turret 134 (FIG. 1) or discharged from the converter 100. Like the heating station 202, the separating station 206 may also include a burner positioner 318 coupled to the separating burner 348. The burner positioner 318 may be operable to positon the separating burner 348 vertically (e.g., in the +/−Z direction of the coordinate axis in FIG. 3), horizontally (e.g., in the X-Y plane identified by the coordinate axis in FIG. 7), or a combination of these directions relative to the glass tube 102 in the separating station 206.

In conventional converters, gas burners are mainly used in for pre-heating, shaping, and separating steps. In the heating stations 202, extensive heating is required to increase the temperature of the glass tube to a temperature suitable for thermal forming or separation, such as temperatures of greater than or equal to 1000° C., depending on glass composition. Then additional heating with different flame configurations are applied to enable forming of the product using mechanical glass shaping tools followed by separation of the parts, inspection, annealing, and packaging of the final product. While existing converting processes using gas burners for heating and separating are well established and have been in use for quite a long period of time, these conventional converting processes have a number of challenges and areas for improvement, especially considering increasing demand for pharmaceutical products and increasing focus on high quality, manufacturing efficiency, and environmental sustainability of the processes.

One of the challenges with the existing conventional converting processes is manufacturing throughput. Typically, the part rate in vial production is in the range of about 30-60 parts per minute, depending on wall thickness, nominal diameter of the glass tube, and/or glass composition of the glass tube. The bottleneck to increasing the part rate fundamentally lies in glass heating efficiency of the gas burners, which is limited by surface absorption of the heat and by heat conductivity through the glass body. Finding a new heat source, as an alternative to the flame from the gas burners, with potentially higher heat transfer through the glass, could enabling increasing the part rate of the converter. Further, gas burners for heating can be imprecise, sometimes unstable, and more difficult to control due to the time lag between changing the flow rates of air and/or fuel to the gas burner and the change in heating rate. The reduced precision, stability, and control of gas burners lead to inaccuracies in the dimensions of the finished glass articles, which can increase the number of rejects and reduce the overall yield of the glass articles from the glass tubes. Providing a new heat source that is more precise, stable, and better controlled compared to gas burners can provide better dimensional accuracy of the glass articles, reduced number of rejects, and greater yield.

Further, the use of gas burners can result in undesired contamination of the surfaces of the glass articles, such as contamination resulting from contact of the gas burner flames with the glass tube and chemical reactions and interaction between the glass and the combustion products. Further, gas burners in conventional converters combust fossil fuels, such as natural gas, and produce combustions products that are exhausted from the process. These combustions gases often need to be treated prior to discharge. The use of fossil fuels to power the gas burners further may increase the carbon footprint of the converting process.

The present application is directed to a converter and converting process that includes application of high-intensity laser radiation in the far infra-red spectrum (i.e., wavelength of from about 4 μm to about 12 μm), where the glass is essentially non-transparent, as an alternative heat source for heating the glass tubes, separating the articles from the working end of the glass tubes, or both. In particular, the present application is directed to systems for producing glass articles from glass tubes, where the system comprises a converter having a plurality of processing stations and at least one laser system position in at least one heating station, in the separating station, or combinations of these. The laser system is operable to generate a laser beam, modify one or more properties of the beam, and direct the laser beam at the glass tube in the heating station, separating station or both. The laser beam(s) are generated by the laser system or laser systems working in the IR wavelength range having high absorption in the glass, which is essentially non-transparent to the laser radiation.

The present application is also directed to methods for converting glass tubes to a plurality of glass articles using the systems disclosed herein. The methods of the present disclosure are based on fast heating of glass tubes by the laser beams of different shape and spatial power distribution up to the temperatures at which the glass viscosity allows shaping (forming) by external mechanical shaping tools, by stretching or compressive forces in combination with internal glass stress, surface tension and, in some cases, gravity. Heating the glass tubes with the laser beam(s) may be used for separating the glass articles from the working end of the glass tubes.

The systems and method disclosed herein may enable more stable, precise, and controllable methods of heat delivery to the glass tubes due to a well-defined area affected by the laser beam and stability of the laser power over extended periods of time. Precise heating by the laser systems can reduce variations of dimensions of the final parts, reduce the number of rejects and increase yield by tightly controlling glass viscosity during forming and separating steps. In particular, the laser power of the laser systems herein can be tightly controlled to provide uniform heating to the glass tube without causing damage to the glass, such as through ablation or evaporation of the glass caused by excessive laser power. The use of the laser beam can enable tight control of the area and/or volume of glass heated by the laser beam. The laser systems providing the laser heat source can be integrated into conventional converting equipment, which may reduce the number of burners in a hybrid system or allow design of an all-laser converting system. Single or multiple laser systems can be used to enable tube pre-heat, bottom forming, and separation with different beam shapes, orientation and power. Laser beam optics enables precise beam focusing on the glass and is immune to alignment sensitivities that burners may prone to as they wear or change overtime due to degradation or machining tolerances.

The laser systems in the separating station can enable the separation process to be tailored to create a bottom of the glass article or to separate the glass article while maintaining an open end of the glass article and glass tube. When forming a bottom or an open end to the glass article, the laser systems in the separating station can enable separation of the glass article and finishing of the end of the glass article to be accomplished in a single processing step using a single processing station. Transitioning from forming an open end to forming a bottom on the glass article can be accomplished with a quick and easy modification to the size, shape, orientation, or power density of the laser beam. The size, shape, orientation, and power density of the laser beam can also be adjusted to change the thickness of the bottom of the glass article.

The systems and methods disclosed herein does not use combustion of gases to heat the glass and does not generate combustion products. The reduction in combustions products may reduce contamination of the glass through contact of the burner flame with the glass and chemical reactions and interactions with the combustion products. Reduction in the use of burners may improve the chemical neutrality of the converting process. Reducing the number of gas burners may also reduce or eliminate process exhaust of the combustion products, which may be more environmentally friendly and contribute to greener manufacturing practices, among other features.

Referring again to FIGS. 1, one embodiment of a system 400 of the present disclosure for producing glass articles from glass tubes 102 is graphically depicted. The systems 400 may include the converter 100 comprising the plurality of processing stations 122 spaced apart in a circuit and at least one holder 140. The converter 100 may have any combination of the features previously discussed herein for the converter 100. In embodiments, the plurality of processing stations 122 comprise at least one heating station, at least one forming station, and a separating station. Each of the holders 140 is operable to hold a glass tube 102 and rotate the glass tube 102 about the center axis A of the glass tube 102. The converter 100 is operable to translate the holders 140 and the glass tubes 102 secured therein through each of the processing stations 122 in succession. The system 400 may further include at least one laser system 410, such as one or a plurality of laser systems 410. The at least one laser system 410 may be disposed in at least one heating station, at least one separating station, or both. The laser system 410 may include a laser source 412 and a beam delivery system 420. The laser system 410 may be operable to generate a laser beam 414, modify one or more properties of the laser beam 414, and direct the laser beam 414 at the glass tube 102 when the glass tube 102 is in the heating station or the separating station.

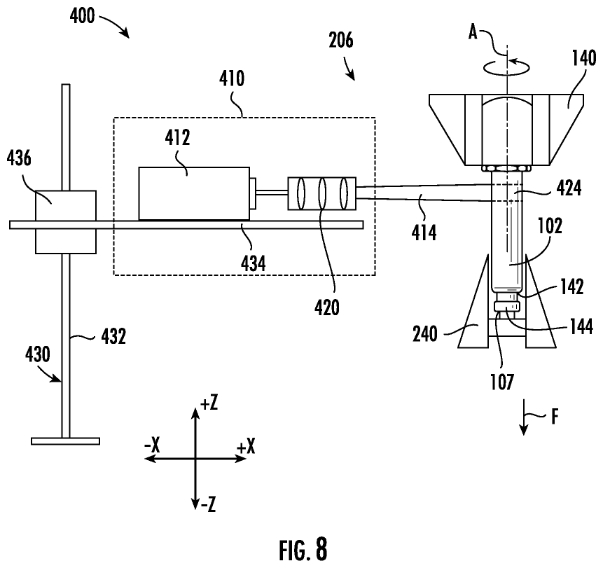

Referring now to FIG. 8, the laser system 410 may comprise the laser source 412 operable to produce the laser beam 414 and the beam delivery system 420 operable to shape the laser beam 414 and direct the laser beam 414 to the glass tubes 102 in the separating station or a heating station. In FIG. 8, the laser system 410 is depicted in a laser separating station 440 operable to separate the glass article from the working end 107 of the glass tube 102. Additionally or alternatively, in embodiments, the laser system 410 may be disposed in a heating station 202, such as the heating station 202 depicted in FIG. 21.

The laser source 412 may be operable to produce the laser beam 414. The laser beam 414 may have a wavelength in a wavelength range that allows the laser beam 414 to be absorbed by the glass of the glass tubes 102 to heat the glass and does not pass through the glass to a great extent (i.e., very little of the laser beam 414 passes through the glass). Because silicate-based glasses have strong absorption of light having wavelengths greater than or equal to about 4 micrometers (μm), many different laser sources can be used to produce the laser beam 414. The laser source 412 may be operable to produce the laser beam 414 having a wavelength in the infrared wavelength region, such as the far infrared region. The laser source 412 may be operable to produce the laser beam 414 having a wavelength of greater than or equal to about 1 μm, greater than or equal to about 2 μm, greater than or equal to about 3 μm, greater than or equal to about 4 μm, or even greater than or equal to about 8 μm. The laser source 412 may be operable to produce the laser beam 414 having a wavelength of less than or equal to about 12 μm, or even less than or equal to about 11 μm. The laser source 412 may be operable to produce the laser beam 414 having a wavelength of from about 1 μm to about 12 μm, from about 1 μm to about 11 μm, from about 2 μm to about 12 μm, from about 2 μm to about 11 μm, from about 3 μm to about 12 μm, from about 3 μm to about 11 μm, from about 4 μm to about 12 μm, from about 4 μm to about 11 μm, from about 5 μm to about 12 μm, from about 5 μm to about 11 μm, from about 8 μm to about 12 μm, or from about 8 μm to about 11 μm. The specific wavelength range may depend, in part, on the type of glass composition comprising the glass tubes 102.

The laser source 412 may be operable to produce the laser beam 414 that is an infrared laser beam. In embodiments, the laser source 412 may be a CO laser, a CO₂ laser, a quantum cascade laser (QCL), or other type of suitable laser capable of producing the laser beam 414 having a wavelength in the above range. The laser source 412 may be operable to produce the laser beam 414 that is continuous or pulsed. Continuous lasers generally have lower peak power and raise the glass surface temperature gradually, while pulsed lasers generally have high peak power and raise glass surface temperature to a greater degree in a shorter period of time compared to continuous lasers.

Referring again to FIG. 1, the beam delivery system 420 may be positioned downbeam from the laser source 412. The beam delivery system 420 may be operable to modify the characteristics of the laser beam 414, such as the shape, power density distribution, other beam characteristics, or combinations thereof. The beam delivery system 420 further may be operable to direct the laser beam 414 to the glass tubes 102 when the glass tubes 102 are disposed in a processing station 122, such as the separating station 206, one of the heating stations 202, or combinations of these. The beam delivery system 420 may comprise one or more shaping optics, turning mirrors, beam splitters, or combinations of these. In embodiments, the beam delivery system 420 may comprise at least one shaping optic, and at least one turning mirror.

The shaping optics may include one or more lenses, mirrors, or both that are operable to modify a shape the laser beam 414. The laser beam 414 produced by the laser source 412 may be a round Gaussian laser beam. The beam delivery system 420 may include optical components that transform the round shape of laser beam 414 to an elliptical beam, change the dimensions (e.g., length and width) of the laser beam 414, and/or change the power density distribution along one or both axis of the elliptical laser beam. In embodiments, the beam delivery system 420 may comprise one or more variable beam expanders (e.g., zoom telescope lenses), cylindrical lenses, aspheric-cylindrical lenses, polygon mirrors, or combinations thereof to modify a beam size, beam shape, beam power density distribution, or combinations thereof. In embodiments, the beam delivery system 420 may comprise one or more zoom telescope lenses or other variable beam expanders, which may be operable to modify the beam size, such as by increasing the beam size, of the laser beam 414. In embodiments, the beam delivery system 420 may comprise one or more cylindrical lenses, which may be operable to modify the shape of the laser beam 414, such as modifying the beam length, beam width, or both of the laser beam 414. In embodiments, the beam delivery system 420 may comprise a plurality of cylindrical lenses operable to transition the laser beam 414 from having a round shape to having an elliptical shape. The plurality of cylindrical lenses may also expand or compress the laser beam 414 to produce a beam having the target dimensions (e.g., length and beam width) at the point where the laser beam 414 contacts the glass tubes 102.

In embodiments, the beam delivery system 420 may include one or more lenses operable to change the power density distribution of the laser beam 414. In embodiments, the beam delivery system 420 may include one or more spherical cylindrical lenses operable to produce the laser beam 414 having a Gaussian power density distribution. In embodiments, the beam delivery system 420 may comprise one or more aspheric-cylindrical lenses operable to produce the laser beam 414 having a flat-top power density distribution. In embodiments, the beam delivery system 420 may include one or more polygon mirrors, which may be operable to modify the power density distribution of the laser beam 414. In embodiments, the laser beam 414 is an elliptical beam and the cylindrical lens, aspheric-cylindrical lens, or polygon mirror may be configured to modify the power density distribution in the direction of the major axis.

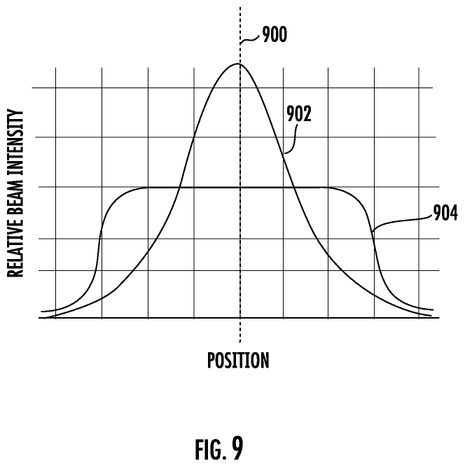

Referring now to FIG. 9, the power densities (y-axis) as a function of position in the beam (x-axis) for two different power density distributions of the laser beam are graphically depicted. The position in the beam in FIG. 9 refers to the position in laser beam in a direction along the major axis of the elliptical beam. As shown in FIG. 9, a Gaussian power density distribution 902 is characterized by a maximum laser power density at the center 900 of the laser beam and decreasing power density with increasing distance from the center 900 of the laser beam. In contrast, the flat-top power density distribution 904 has a smaller maximum power density but the power density is more uniform over the majority of the major axis of the laser beam.

Referring again to FIG. 8, the beam delivery system 420 may include any other optical components, such as but not limited to mirrors, lenses, beam splitters, prisms, filters, apertures, etc., operable to modify one or more characteristics of the laser beam 414 upbeam of the point where the laser beam 414 is incident on the glass tubes 102. The beam delivery system 420 may provide for adjustment of the distance between the various components (e.g., lenses, mirrors, filters, prisms, etc.), within limits. Some adjustment of the distance between the optical components of the beam delivery system 420 may enable fine tuning of the dimensions and position of the laser beam 414 at the point where the laser beam 414 contacts the glass tube 102 in the processing station. In embodiments, the beam length and beam width of the laser beam 414 can be modified by changing the distances between lenses and other optical components in the beam delivery system 420.

As shown in FIG. 8, in embodiments, the laser system 410 may be oriented so that the laser beam 414 travels directly in a straight line from the laser source 412, through the beam delivery system 420, to the glass tube 102. Referring now to FIG. 10, in embodiments, the laser system 410 may not be oriented so that the laser beam 414 can travel in a straight line between the laser source 410 and the glass tube 102, due to space constraints or other considerations. In embodiments, the laser system 410 may include one or more turning mirrors 422, which may be operable to direct the laser beam 414 towards the glass tube 102 in the processing station 122. The turning mirrors 422 may enable the laser source 412 and beam delivery system 420 to be mounted a distance away from the converter 100 or above the converter 100 while still being able to deliver the laser beam 414 to the target location on the glass tube 102 in the processing station 122. In embodiments, the laser system 410 may include one or more beam splitters 460, which may be operable to divide the laser beam 414 into two or more separate laser beams 414, which can be directed to different processing stations 106 of the converter 100.

Referring again to FIG. 8, in embodiments, the system 400 may further include a laser system positioner 430 operatively coupled to the laser system 410. The laser system positioner 430 may be operable to change a vertical position (i.e., a position in the +/−Z direction of the coordinate axis in FIG. 8) of the laser system 410, which may change a vertical position of the laser beam 414 relative to the glass tube 102. The laser system positioner 430 may also be able to change a direction of the laser system 410 in the horizontal plane (i.e., the X-Y plane in the coordinate axis in FIG. 8). The laser system positioner 430, one or more turning mirrors 422 (FIG. 10), or both may be used to change the beam path so that the laser beam 414 is incident on the outer surface of the glass tube 102 in the processing station 122 (e.g., heating station and/or separating station). The laser system positioner 430 may include any apparatus or collections of apparatus operable to change a position of the laser system 410. In embodiments, the laser system positioner 430 may include at least one rail 432, a laser support 434 coupled to the laser system 410, and an actuator 436 movably securing the laser support 434 to the rail 432. The actuator 436 may be operable to translate the laser support 434 and laser system 410 along the rail 432 in the +/−Z direction of the coordinate axis in FIG. 8. The actuator 436 may be a stepper motor or other device operable to move the laser support 434 along the rail 432 in the +/−Z direction of the coordinate axis in FIG. 8. Although depicted in FIG. 8 as having a rail 432, laser support 434, and actuator 436, it is understood that the laser system positioner 430 may include any other type of apparatus, such as hydraulic or pneumatic positioners, scissor lifts, pulleys, robotics, or other devices or combinations of devices suitable for moving the laser system 410 relative to the glass tubes 102 in the processing station. In embodiments, the laser system positioner 430 may be manually adjusted to change the position of the laser support 434.

In embodiments, the laser system positioner 430, turning mirrors 422, or both may be operable to position the laser system 410 relative to the glass tube 102 so that the glass tube 102 is located in the center of the beam waist of the laser beam 414. The beam waist refers to the region of the beam path of the laser beam 414 at which the power density of the laser beam 414 is the greatest. In embodiments, the laser system positioner 430 may be adjusted to position the laser system 410 so that the glass tubes 102 are disposed in converging or diverging sections of the laser beam 414 to reduce the power density of the laser beam 414 at the point along the beam path where the laser beam 414 is incident on the glass tube 102. Changing the position of the laser system 410 to move the beam waist closer to the glass tubes 102 may increase the power density of the laser beam 414 at the point where the laser beam 414 contacts the glass tubes 102. Conversely, changing the position of the laser system 410 to move the beam waist further away from the glass tubes 102 may decrease the power density of the laser beam 414 at the point where the laser beam 414 contacts the glass tubes 102.

Additionally, moving the position of the laser system 410 to change the distance between the laser system 410 and the glass tube 102 may also change the beam size. For instance, changing the distance between the laser system 410 and the glass tube 102 to move the beam waist further away from the glass tube 102 (e.g., positioning the glass tube 102 further into the converging or diverging portions of the beam path) may result in the laser beam 414 having a greater beam width and length at the point in the beam path where the laser beam 414 is incident on the outer surfaces of the glass tube 102. Conversely, changing the distance between the laser system 410 and the glass tube 102 to move the beam waist of the laser beam 414 closer to the glass tube 102 may result in the separating laser beam 132 having a reduced beam width and length of the laser beam 414 at the point in the beam path where the laser beam 414 is incident on the outer surface of the glass tube 102.

Referring again to FIG. 8, general operation of the laser system 410 comprises producing the laser beam 414 using the laser source 412 and passing the laser beam 414 through the beam delivery system 420 that includes optics that modify the shape, power density distribution, or both of the laser beam 414. The laser beam 414 is then directed towards the separating region 424 or target region 426 (FIG. 21) of the glass tube 102. The laser system positioner 430, one or more turning mirrors 422, or both may be used and/or adjusted to direct the laser beam 414 towards the separating region 424 or target region 426 (FIG. 20) of the glass tube 102.

Referring again to FIG. 8, the laser beam 414 may have a wavelength of from 1 μm to 12 μm, from 1 μm to 11 μm, from 1 μm to 10 μm, from 2 μm to 12 μm, from 2 μm to 11 μm, from 2 μm to 10 μm, from 3 μm to 12 μm, from 3 μm to 11 μm, from 3 μm to 10 μm, from 4 μm to 12 μm, from 4 μm to 11 μm, from 4 μm to 10 μm, from 5 μm to 12 μm, from 5 μm to 11 μm, from 5 μm to 10 μm, from 8 μm to 12 μm, from 8 μm to 11 μm, or from 8 μm to 10 μm. In embodiments, the laser beam 414 may have a wavelength of from about 5 μm to about 11 μm. The laser beam 414 may be a continuous laser beam or a pulsed laser beam. The laser beam 414 may be a collimated beam or an un-collimated beam.

The laser beam 414 may have an overall laser power of greater than or equal to 50 watts (W), greater than or equal to 100 W, greater than or equal to 200 W, or greater than or equal to 500 W. In embodiments, the laser beam 414 may have an overall laser power of from 50 W to 2000 W, from 50 W to 1500 W, from 50 W to 500 W, from 50 W to 200 W, from 100 W to 2000 W, from 100 W to 1500 W, from 100 W to 500 W, from 100 W to 200 W, from 200 W to 2000 W, from 200 W to 1500 W, from 200 W to 500 W, from 500 W to 2000 W, from 500 W to 1500 W, from 500 W to 1000 W, from 1000 W to 2000 W, or even from 1000 W to 1500 W. The laser power of the laser beam 414 can be adjusted depending on the beam width of the laser beam 414, with the power increasing for increasing beam width of the laser beam 414. In embodiments, the laser beam 414 may be an elliptical beam with a narrow beam width (FIG. 13), and the laser beam 414 may have a laser power of from about 50 W to about 500 W, such as from 50 W to 200 W, from 100 W to 500 W, from 100 W to 200 W, or from 200 W to 500 W. In embodiments, the laser beam 414 may be an elliptical beam with a wide beam width (FIG. 12), and the laser beam 414 may have a laser power of from about 500 W to about 2000 W, such as from 500 W to 1500 W, or from 500 W to 1000 W.

The heating rate of the laser beam 414 for heating the glass tube 102 may be increased or decreased by increasing or decreasing the laser power density of the laser beam 414. In embodiments, the laser beam 414 may have a laser power density sufficient to produce a heating rate of the glass tube of from about 200° C. per second to about 400° C. per second. The laser beam 414 may be characterized by a power density distribution. The heating rate of the laser beam 414 may be modified by changing the power density distribution of the laser beam 414. As previously discussed, in embodiments, the laser beam 414, as modified by the beam delivery system 420, may have a Gaussian power density distribution along the major axis (e.g., length) of the laser beam 414. In embodiments, the laser beam 414, as modified by the beam delivery system 420, may have a flat-top power density distribution along the major axis (e.g., length) of the laser beam 414. The methods disclosed herein may include changing a power density distribution of the laser beam 414, wherein changing the power density distribution changes the heating rate of the laser beam 414.

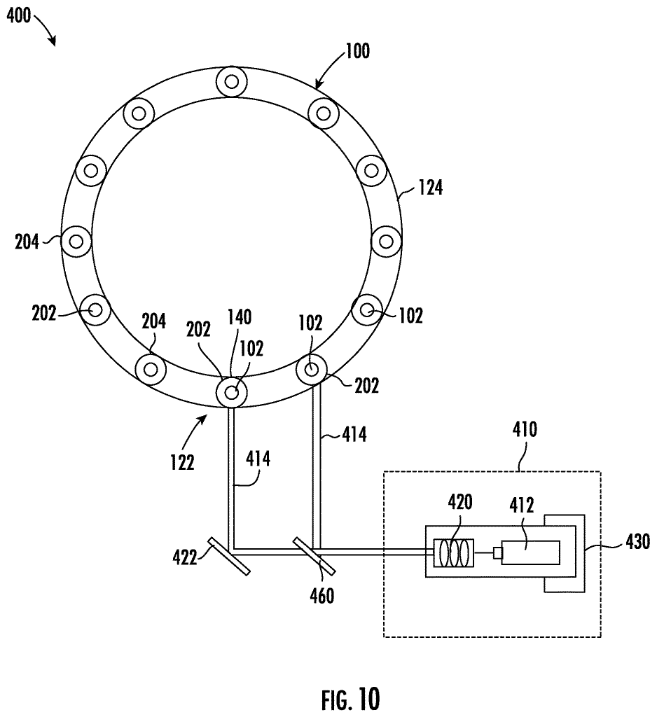

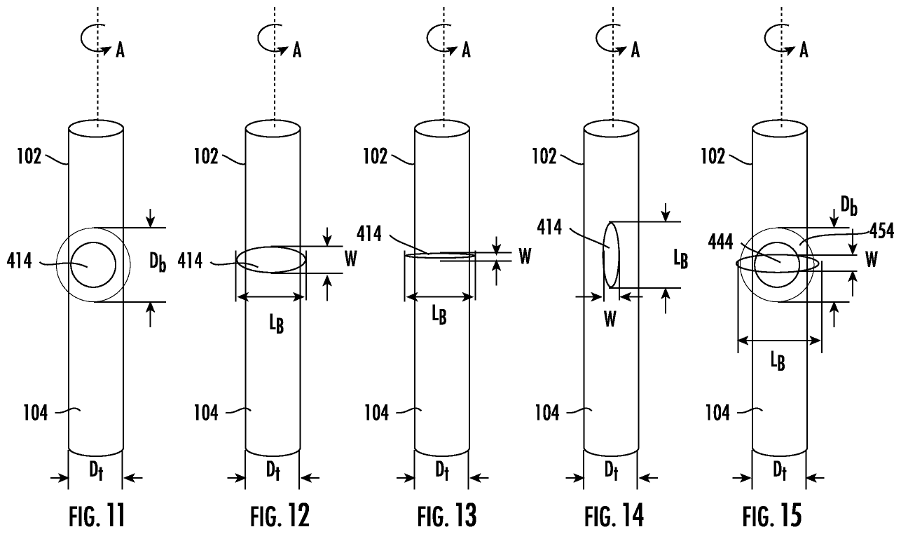

The laser beam 414, as modified by the beam delivery system 420, may be a round beam or an elliptical beam. Referring now to FIG. 11, in embodiments, the laser beam 414 may be a round beam having a cross-sectional shape that is generally circular. When the laser beam 414 is a round beam, the laser beam 414 may have a beam diameter Db that is less than or equal to about 1.25 times the outer diameter Dₜ of the glass tube 102 at the point along the beam path where the laser beam 414 is incident on the outer surface of the glass tube 102. The shape of the beam at the point along the beam path where the laser beam 414 is incident on the outer surface of the glass tube 102 refers to the cross-sectional shape of the laser beam 414 in a plane perpendicular to the beam path where the plane is located along the beam path at the point where the laser beam 414 first contacts the outer surface of the glass tube 102. In embodiments, the laser beam 414 may have a beam diameter Db that is less than or equal to about 1.25 times the outer diameter of the glass tube 102, such as from about 0.5 to about 1.25, from about 0.5 to about 1.1, from about 0.5 to about 1, from about 0.75 to about 1.25, from about 0.75 to about 1.1, from about 0.75 to about 1, from about 0.9 to about 1.25, from about 0.9 to about 1.1, from about 0.9 to about 1, from about 1 to about 1.25, or from about 1 to about 1.1 times the outer diameter of the glass tube 102. In embodiments, the laser beam 414 may be a round beam having a beam diameter Db of from about 5 mm to about 50 mm at the point along the beam path where the laser beam 414 is incident on the outer surface of the glass tube 102. In embodiments, the laser beam 414 may be a round beam having a beam diameter Db of greater than about 50 mm.

Referring now to FIGS. 12-14, in embodiments, the laser beam 414 may be an elliptical beam having a major axis and a minor axis. When the laser beam 414 is an elliptical beam, the beam delivery system 420 may be configured to orient the laser beam 414 so that the major axis of the elliptical-shaped laser beam 414 is perpendicular to (FIGS. 12 and 13) or parallel to (FIG. 14) the center axis A of the glass tube 102. Referring to FIGS. 12 and 13, in embodiments, the laser beam 414 may have a ratio of the major axis to the minor axis of greater than or equal to 2, greater than or equal to 5, or even greater than or equal to 10 at the point along the beam path where the laser beam 414 is incident on the outer surface of the glass tube 102. In embodiments, the laser beam 414 may be an elliptical laser beam having a ratio of the major axis to the minor axis of from about 2 to about 100, from about 2 to about 70, from about 2 to about 40, from about 5 to about 100, from about 5 to about 70, from about 5 to about 40, from about 10 to about 100, from about 10 to about 70, from about 10 to about 40, from about 40 to about 100, or from about 40 to about 70 at the point along the beam path where the laser beam 414 is incident on outer surface of the glass tube 102.

When the laser system 410 is disposed in a separating station 206, as shown in FIG. 8, the ratio of the major axis to the minor axis (i.e., ratio of the beam length L_{B} to the beam width W) may be modified to produce an open end or a closed end of the glass tube 102 at the working end 107 of the glass tube following separation of the glass article from the working end 107. During separation, at the separating region 424, the glass thins and stretches out until the glass eventually separates to form the glass article 103 separated from the working end 107 of the glass tube 102. Once separated, surface tension within the glass may cause the volumes of viscous glass on either side of the separation point to flow back to the new working end of the glass tube 102 and the end of the glass article 103 at the separation point, respectively. In embodiments, the volume of heated glass may be great enough so that the viscous glass flowing back to the new end of the glass article 103 may form a meniscus over the end of the glass article 103. Forming a meniscus of glass over the end of the glass article 103 may provide a bottom of the glass article 103. In embodiments, the volume of glass heated by the laser beam 414 may not be sufficient to form a meniscus, resulting in a new end of the glass article 103 being open.

Referring again to FIGS. 12 and 13, the ratio of the major axis to the minor axis of the laser beam 414 influences the volume of glass of the glass tube 102 heated in the separating station 206. Referring to FIG. 13, to form an open end at the working end 107 of the glass tube 102 after separation, the laser beam 414 may be an elliptical beam having a large ratio of the major axis to minor axis, which results in a thin beam that heats a small volume of glass that is just enough volume of glass to separate the glass article from the glass tube 102 but not enough to form a meniscus of glass over the ends of the glass tube 102 and glass article. In embodiments, the separating station may be configured to form open ends on the glass tube and glass article, and the laser beam 414 may be an elliptical beam having a ratio of the major axis to minor axis (i.e., ratio of beam length L_{B} to beam width W) of from about 4 to about 100, such as from about 4 to about 70, from about 5 to about 100, from about 5 to about 70, from about 10 to about 100, from about 10 to about 70, from about 12 to about 100, from about 12 to about 70, from about 15 to about 100, from about 15 to about 70, or from about 20 to about 100 at the point along the beam path where the laser beam 414 is incident on outer surface of the glass tube 102. The ratio of the major axis to the minor axis of the laser beam 414 for producing an open bottom may depend on the outer diameter, wall thickness, glass composition, or combinations thereof of the glass tube 102 being processed.

Referring now to FIG. 12, to form closed ends at the working end 107 of the glass tube 102 and the glass article after separation, the laser beam 414 may be an elliptical beam having a ratio of the major axis to the minor axis that is smaller so that the laser beam 414 heats a larger volume of glass that is sufficient to form a meniscus of glass over the working end of the glass tube 102 and the glass articles. In embodiments, the separating station may be configured to form closed ends on the glass tube 102 and glass article, and the laser beam 414 may be an elliptical beam having a ratio of the major axis to minor axis (i.e., ratio of beam length L_{B} to beam width W) of from about 2 to about 12, such as from about 2 to about 10, from about 2 to about 8, or from about 2 to about 5 at the point along the beam path where the laser beam 414 is incident on outer surface of the glass tube 102. The ratio of major axis to the minor axis of the laser beam 414 for producing a closed bottom may depend on the outer diameter, wall thickness, glass composition, or combinations thereof of the glass tube 102 being processed. When forming a closed end on the working end of the glass tube 102 in the separating station 206, a closed end is also formed on the end of the glass article separated from the glass tube 102. This closed end of the glass article may become the bottom of the glass article, such as in the case of the glass article being a vial, jar, or other closed bottom container.

Referring to FIGS. 12-14, in embodiments, the laser beam 414 may be an elliptical beam and may have a beam length L_{B} that is less than or equal to about 1.25 times the outer diameter of the glass tube 102, such as from about 0.5 to about 1.25, from about 0.5 to about 1.1, from about 0.5 to about 1, from about 0.75 to about 1.25, from about 0.75 to about 1.1, from about 0.75 to about 1, from about 0.9 to about 1.25, from about 0.9 to about 1.1, from about 0.9 to about 1, from about 1 to about 1.25, or from about 1 to about 1.1 times the outer diameter of the glass tube 102. In embodiments, the laser beam 414 may be an elliptical beam and may have a beam length L_{B} of from about 5 mm to about 50 mm. In embodiments, the beam length L_{B} may even be greater than about 50 mm. The beam length L_{B} of the laser beam 414 refers to a distance across the laser beam 414 along the major axis at the point along a beam path where the laser beam 414 is incident on the outer surface 104 of the glass tube 102. As used herein, the beam length L_{B} of the laser beam 414 refers to the maximum distance across the laser beam 414 in the direction parallel to the major axis at the point rather than an average of the length taken over the beam width. For an elliptical beam, the beam length L_{B} is equal to the length of the major axis of the elliptical beam at the point along a beam path where the laser beam 414 is incident on the outer surface of the glass tube 102. In embodiments, the beam length L_{B} of the elliptical-shaped laser beam 414 may be selected based in part on the outer diameter Dₜ of the glass tube 102.

The laser beam 414 may have a beam width W of from about 0.5 mm to about 20 mm at the point along the beam path where the laser beam 414 is incident on the outer surface of the glass tube 102. The beam width W refers to the maximum width of the beam along in a direction parallel to the minor axis of the laser beam 414 at the point along the beam path where the laser beam 414 is incident on the outer surface 104 of the glass tube 414. For an elliptical beam, the beam width W is equal to the length of the minor axis of the elliptical beam. In embodiments, the laser beam 414 may have a beam width W of from 0.5 mm to 10 mm, from 0.5 mm to 7 mm, from 0.5 mm to 5 mm, from 0.5 mm to 3 mm, from 0.5 mm to 2 mm, from 1 mm to 20 mm, from 1 mm to 10 mm, from 1 mm to 7 mm, from 1 mm to 5 mm, from 1 mm to 3 mm, from 1 mm to 2 mm, from 2 mm to 20 mm, from 2 mm to 10 mm, from 2 mm to 7 mm, from 2 mm to 5 mm, from 2 mm to 3 mm, from 3 mm to 20 mm, from 3 mm to 10 mm, from 3 mm to 7 mm, from 3 mm to 5 mm, from 5 mm to 20 mm, from 5 mm to 10 mm, from 5 mm to 7 mm, from 7 mm to 20 mm, from 7 mm to 10 mm, or even from 10 mm to 20 mm at the point along the beam path where the laser beam 414 is incident on the outer surfaces of the glass tubes 102.

The beam width W of the laser beam 414 may be selected based on the wall thickness, nominal diameter, glass composition, or combinations thereof of the glass tubes 102. When the laser system 410 is disposed in the separating station 206, the beam width W of the laser beam 414 may be modified to change the volume of glass heated during separation of the glass article from the working end 107 of the glass tube 102. Changing the volume of glass heated during separation can enable formation of an open end or a closed end on both the working end of the glass tube 102 and on the end of the glass article separated therefrom.

Referring now to FIG. 13, in embodiments, reducing the beam width W of the laser beam 414 into a range of from about 0.5 mm to about 5 mm, or from about 0.5 mm to about 3 mm may result in forming open ends of the glass tube 102 and glass article during separation, depending on the thickness, outer diameter Dₜ, and glass composition of the glass tube. Referring now to FIG. 12, increasing the beam width W of the laser beam 414 into a range of from about 3 mm to about 20 mm, or from about 5 mm to about 10 mm, as shown in FIG. 12, may result in forming closed ends of the glass tube 102 and glass article during separation, depending on the thickness, outer diameter, and glass composition of the glass tube. When forming a closed end to the glass tube 102 and glass article during separation, further increasing the beam width W of the laser beam 414 may further increase the volume of glass heated during separation, which may increase a thickness of the closed ends, thereby increasing a thickness of the bottom of the glass article produced. Likewise, decreasing the beam width W of the laser beam 414 may reduce the volume of glass heated during separation, which may result in a thinner closed end and thinner bottom of the glass article. Changing the shape of the laser beam, such as by changing the beam length L_{B} and/or the beam width W, may change a volume of the glass heated in the target region or the separating region of the glass tube 102.

Referring now to FIG. 14, in embodiments, the optics of the beam delivery system 420 may be configured to shape the laser beam 414 into an elliptical-shaped beam and to orient the laser beam 414 to that the major axis of the elliptical cross-section is parallel to the center axis A of the glass tube 102. Orienting the laser beam 414 so that the major axis is parallel to the center axis A of the glass tube 102 may enable the laser beam 414 to heat a greater volume of the glass during separation of the glass article from the glass tube 102. As shown in FIG. 14, the laser beam 414 may be oriented so that the beam length L_{B} is parallel to the center axis A of the glass tube 102 and the beam width W is perpendicular to the center axis A of the glass tube 102. Orienting the laser beam 414 so that the major axis is parallel to the center axis A of the glass tube 102, as in FIG. 14, may enable forming an even thicker bottom on the glass article compared to just increasing the beam width W of laser beam 414, as shown in FIG. 12.

Referring now to FIG. 15, in embodiments, the laser system 410 may be configured to produce two laser beams and direct the two laser beams onto the outer surface of the glass tube 102. The two laser beams may be produced by having two separate laser sources, or by having a single laser source and splitting the laser beam one or more times. The two laser beam embodiments will be described herein in terms of two separate laser sources in two separate laser systems, however, it is understood that the two or more laser beams can be produced by producing a single laser beam using a single laser source and then splitting the laser beam using optical components (e.g., beam splitter 460 in FIG. 10) to produce the plurality of laser beams.

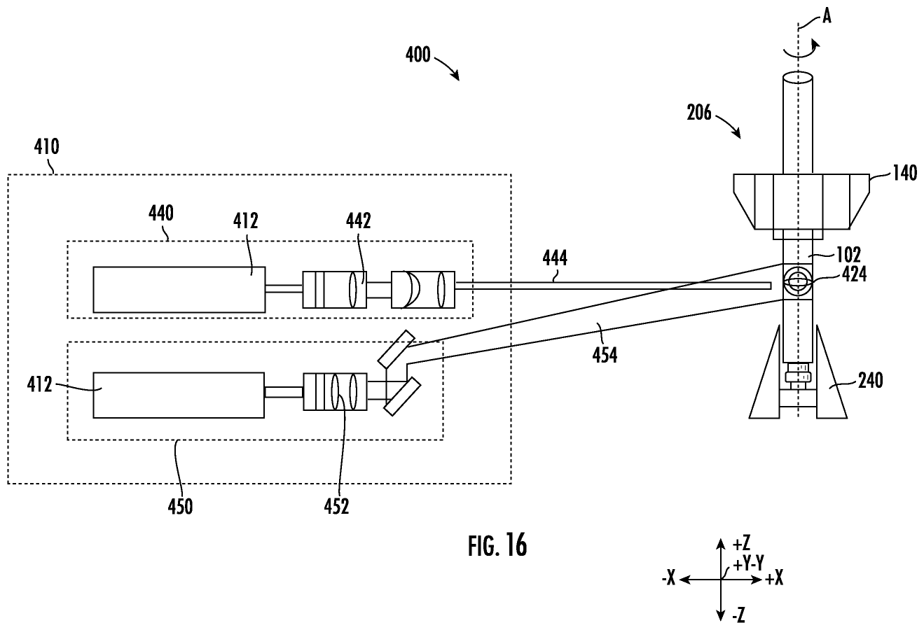

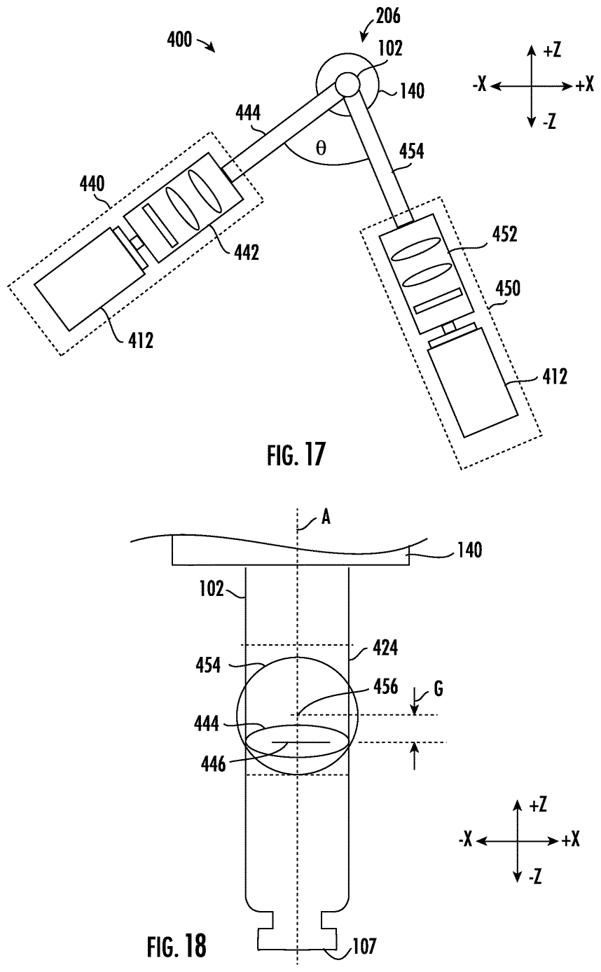

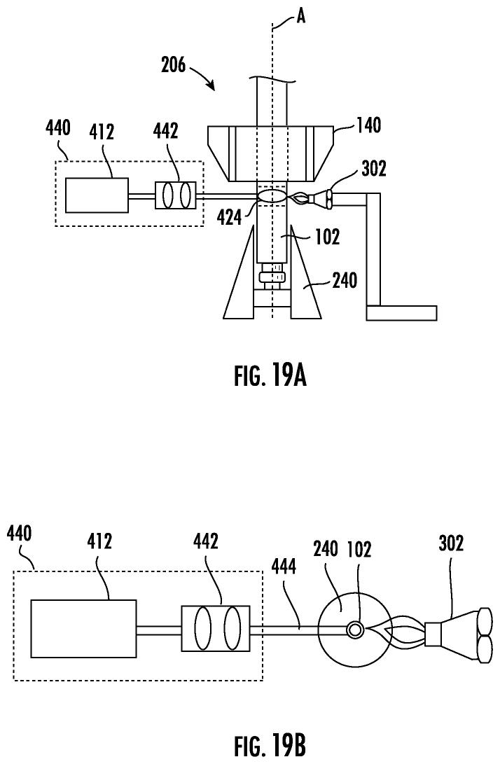

Referring now to FIG. 16, in embodiments, the laser system 410 may comprise a separating laser system 440 and a preheating laser system 450. The separating laser system 440 may produce a separating laser beam 444, the preheating laser beam 450 may be operable to produce a preheating laser beam 454, and the separating laser beam 444 and the preheating laser beam 454 may be directed onto the glass tube 102 in the separating station 206. In embodiments, the separating laser beam 444 and the preheating laser beam 454 may be superimposed on one another at the point where the beams are incident on the outer surface of the glass tube 102. Each of the separating laser system 440 and the preheating laser system 450 may include a laser source 412 as previously described herein.

The separating laser system 440 may comprise a separating beam delivery system 442 disposed downbeam from the laser source 412. The separating beam delivery system 442 may be operable to modify a shape of the separating laser beam 444 to have an elliptical cross-sectional shape with the desired beam length and beam width. The separating beam delivery system 442 may have any of the components or features previously described in conjunction with the beam delivery system 420. The separating laser beam 444 may have an elliptical cross-section and may have a wavelength, laser power density, power density distribution, beam shape, or any other feature previously described in conjunction with laser beam 414.

The preheating laser system 450 may comprise a preheating beam delivery system 452 downbeam from the laser source 412. The preheating beam delivery system 452 may be operable to produce the preheating laser beam 454 having a round cross-sectional shape with the desired beam diameter. The preheating beam delivery system 452 may have any of the components or features previously described in conjunction with the beam delivery system 420. The preheating laser beam 454 may have a wavelength, laser power density, power density distribution, beam shape, or any other feature previously described in conjunction with laser beam 414. In embodiments, the preheating laser system 450 further may include one or more turning mirrors 422 operable to direct the preheating laser beam 454 to the glass tube 102 Although not shown in FIG. 16, in embodiments, the separating laser system 440 may include one or more turning mirrors 422 operable to direct the separating laser beam 444 to the glass tube 102. The separating laser system 440, the preheating laser system 450, or both may further include a laser system positioner 430 (FIG. 8).

Referring again to FIG. 15, superposition of the preheating laser beam 454 and the separating laser beam 444 on the separating region 424 of the glass tube 102 is schematically depicted. As shown in FIG. 15, the separating laser beam 444 may be an elliptical laser beam having an elliptical cross-section, and the preheating laser beam 454 may be a round beam having a generally circular cross section. The laser system positioners 430 (FIG. 8) may be operated to change the relative positions of the separating laser beam 444 and the preheating laser beam 454.

Referring again to FIG. 8, the separating station 206 of the converter 100 may comprise one or a plurality of the laser systems 410 in place of separating burners to separate the glass article from the glass tube 102. In embodiments, the separating station 206 may comprise a single laser system 410, which may be operable to produce a single laser beam 414 having an elliptical cross-section. Referring to FIG. 16, in embodiments, the separating station 206 may comprise a laser system 410 capable of producing a plurality of laser beams, such as a laser system 410 comprising the separating laser system 440 and the preheating laser system 450, as previously discussed herein. The separating station 206 may include one or a plurality of the laser system positioners 430 operable to change a position of one or more of the laser beams (e.g., laser beam 414, separating laser beam 444, preheating laser beam 454, or combinations thereof) relative to the glass tube 102. In embodiments, the separating station 206 may further include a chuck 240, roller, or other device operable to apply a downward force on the glass article during separation of the glass article from the working end 107 of the glass tube 102.

Referring again to FIG. 8, operation of the separating station 206 comprising the laser system 410 to separate the glass article from the working end 107 of the glass tube 102 will now be described in further detail. Separating the glass article from the working end 107 of the glass tube 102 may include translating the holder 140 and glass tube 102 into the separating station 206. The holder 140 may rotate the glass tube 102 about the center axis A of the glass tube 102. Separating the glass article from the glass tube 102 may further include exposing a separating region 424 of the glass tube 102 to the laser beam 414, which may heat the glass of the glass tube 102 in the separating region 424. Separating the glass article from the glass tube 102 may further include applying a separating force F on the glass article (e.g., a force applied in an axial direction away from the glass tube 102, such as a force applied in the −Z direction of the coordinate axis in FIG. 8), while exposing the separating region 424 to the laser beam 414. Applying the separating force F to the glass article may cause the glass article to separate from the working end 107 of the glass tube 102 at the separating region 424 once the glass in the separating region 424 reaches a temperature at which the glass is deformable. Heating the glass tube 102 with the laser beam 414 and applying the separating force F may separate the glass article from the glass article from the glass tube 102 and may finish the end of the glass article.

Exposing the separating region 424 of the glass tube 102 to the laser beam 414 may comprise producing the laser beam 414 with the laser source 412, modifying the laser beam 414 with the beam delivery system 420, and directing the laser beam 414 at the separating region 424 of the glass tube 102. The laser system 410 may be turned on and off to begin and end the exposure of the glass tube 102 to the laser beam 414. In embodiments, separating the glass article from the glass tube 102 may comprise exposing the separating region 424 of the glass tube 102 with the laser beam 414 having a beam width of from about 0.5 mm to about 10 mm at the point along the beam path where the laser beam 414 falls incident on the outer surface of the glass tube 102 in the separating region 424. In embodiments, the laser beam 414 may have a wavelength in the range of from about 1 μm to about 12 μm, or from about 5 μm to about 11 μm. The laser beam 414 may have any of the features previously described herein for laser beam 414. Exposing the separating region 424 of the glass tube 102 to the laser beam 414 may heats the glass at the separating region 424 to a separation temperature at which the glass becomes viscous and deformable, such as separation temperatures of greater than or equal to about 1000° C.

The separating region 424 of the glass tube 102 may be exposed to the laser beam 414 for an exposure time sufficient to increase the temperature of the glass to the separation temperature. In embodiments, the exposure time of the glass tube 102 to the laser beam 414 in the separating station 206 may be less than the dwell time of the converter. Separating the glass article from the glass tube 102 further may comprise controlling the exposure time of the glass tube 102 to the laser beam 414 by adjusting the time at which the laser source 412 of the laser system 410 for producing the laser beam 414 is turned on and then turned off.

As previously discussed, the laser beam 414 in the separating station 206 may have a heating rate of the glass tube 102 of from about 200° C. per second to about 400° C. per second. As previously discussed, the heating rate of the laser beam 414 for heating the glass tube 102 may be increased or decreased by increasing or decreasing the laser power density of the laser beam 414, changing the power density distribution of the laser beam 414, changing the shape of the laser beam 414, or combinations of these. In embodiments, decreasing a cross-sectional area of the laser beam 414 at constant power density (e.g., decreasing the diameter of a round beam or decreasing a width of an elliptical beam) may increase the heating rate of the laser beam and decrease the volume of glass heated by the laser beam 414. Conversely, increasing a cross-sectional area of the laser beam 414 may distributed the laser power over a larger area, which may decrease the heating rate, and may increase the volume of glass heated by the laser beam 414.

Referring again to FIG. 8, separating the glass article from the glass tube 102 in the separating station 206 may further include applying the separating force F to the glass article while exposing the separating region 424 of the glass tube 102 to the laser beam 414. Applying the separating force F may move the glass article away from the working end 107 of the glass tube 102 in the axial direction (i.e., in the −Z direction of the coordinate axis in FIG. 8). In embodiments, the glass tube 102 may be oriented vertically in the separating station with the working end 107 of the glass tube 102 facing downward (i.e., in the −Z direction), and the separating force F may include the force of gravity. In embodiments, applying the separating force F may comprise applying a mechanical separating force to the glass article. Applying a mechanical force to the glass article in the separating station may assist in separating the glass article from the glass tube 102 when the weight of the glass article is insufficient for gravity alone to separate the glass article from the glass tube or when the glass tube 102 is not vertically oriented in the separating station (e.g., when the converter is horizontally oriented instead of vertically oriented). In embodiments, the separating station 206 may comprise a chuck, angled roller, or other device capable of applying a mechanical separating force to the glass article.

Referring to FIG. 8, in embodiments, the separating station 206 may comprise a single laser system 410 operable to produce a single laser beam 414. When the separating station 206 comprises a single laser system 410, the laser system 410 may be operable to produce the laser beam 414 having an elliptical cross-section, which may have a major axis and a minor axis. The laser beam 414 that is an elliptical laser beam may have a ratio of the major axis to the minor axis of from about 2 to about 70, or any range in between as previously discussed herein. The laser beam 414 may be oriented so that the major axis is oriented parallel to or perpendicular to the center axis A of the glass tube 102. In embodiments, the laser system 410 may be configured to orient the laser beam 414 with the major axis perpendicular to the center axis A of the glass tube 102. In embodiments, the laser system 410 may be configured to orient the laser beam 414 with the major axis parallel to the center axis A of the glass tube 102.

In embodiments, separating the glass article from the working end 107 of the glass tube 102 may comprise forming open ends at the working end 107 of the glass tube 102 and the glass article during separation of the glass article from the glass tube 102. To form open ends on the working end of the glass tube 102 and the glass article, the laser beam 414 may be modified to reduce the volume of glass heated by the laser beam 414. The volume of glass heated by the laser beam 414 may be reduced by orienting the laser beam 414 so that the major axis is perpendicular to the center axis A of the glass tube 102 and reducing the width of the laser beam 414. To produce the open ends during separation in the separating station 206, the laser beam 414 may have a beam width of from about 0.5 mm to about 5 mm, such as about 0.5 mm to about 4 mm, from about 0.5 mm to about 3 mm, from about 0.5 mm to about 2 mm, from about 1 mm to about 5 mm, from about 1 mm to about 3 mm, or even from about 1 mm to about 2 mm, at the point along the beam path where the laser beam 414 falls incident on the outer surface of the glass tube 102 in the separating region 424. The beam width of the laser beam 414 for producing open ends may adjusted based on the diameter, thickness, glass composition, or combinations of these for the glass tube 102. For instance, for glass tubes 102 having greater thickness and/or greater diameter, the beam width of the laser beam 414 may be increased to heat a greater volume of glass to ensure that separation of the glass article can be accomplished during the dwell time of the converter.

Exposing the separating section 424 of the glass tubes 102 to the laser beam 414 having the narrower beam width may remove the glass article from the working end 107 of the glass tube 102 to produce the new end of the glass tube comprising an opening. The narrower beam width of the laser beam 414 in the range of from 0.5 mm to 5 mm may result in heating a volume of glass in the separating region that is not sufficient to form a meniscus of glass over the new working end 107 of the glass tubes 102. Separating the glass article from the working end of the glass tube 102 while forming an open end at the new working end 107 of the glass tube 102 may enable a downstream piercing station to be removed from the converter or reconfigured into another type of processing station, such as but not limited to a heating station 202, measuring station, cooling station, forming station, loading station, or other type of processing station.

The laser beam 414 may have a beam length that is less than or equal to about 1.25 times the outer diameter of the glass tube 102, such as from about 0.5 to about 1.25 times the outer diameter of the glass tube 102 at the point along the beam path where the laser beam 414 falls incident on the outer surface of the glass tubes 102 in the separating region 424. In embodiments, the laser beam 414 may have a beam length L_{B} of from about 5 mm to about 50 mm, or even greater than about 50 mm, at the point along the beam path where the laser beam 414 falls incident on the outer surface of the glass tubes 102 in the separating region 424. The beam length of the laser beam 414 may depend in part on the outer diameter of the glass tube 102. For producing the open ends on the glass tube 102 and glass article, the laser beam 414 may have a ratio of the major axis to minor axis that is from about 4 to about 70, such as from about 5 to about 70, from about 8 to about 70, from about 10 to about 70, or from about 20 to about 70, at the point along the beam path where the laser beam 414 falls incident on the outer surface of the glass tube 102 in the separating region 424.

In embodiments, separating the glass article from the working end 107 of the glass tube 102 may include forming a bottom of the glass article while separating the glass article from the working end 107 of the glass tube 102. Forming the bottom of the glass article may also form a closed end on the working end 107 of the glass tube 102 following separation. The laser system 410 in the separating station 206 may be configured to produce the closed end on the working end 107 of the glass tube 102 and the end of the glass article separated from the glass tube 102. In particular, the laser system 410 may be configured to produce the laser beam 414 capable of heating volume of glass in the separating region 424 of the glass tube 102, where the volume of glass heated is sufficient to form a meniscus of glass over the working end 107 of the glass tube 102 and over the end of the glass article during separation of the glass article from the glass tube 102.

To heat a greater volume of glass sufficient to form a meniscus of glass over the ends of both the glass tube 102 and glass article, the laser system 410 can be configured to produce the laser beam 414 having a greater beam width at constant beam length compared to the laser beam for making an open end. For forming closed ends, the laser beam 414 in the separating station 206 may have a beam width of from about 3 mm to 10 mm, such as from 5 mm to 10 mm, or from 6 mm to 10 mm at the point along the beam path where the laser beam 414 is incident on the outer surface of the glass tube 102. The beam width of the laser beam 414 for producing the closed ends may be influenced by the diameter, thickness, glass composition, or combinations of these of the glass tube 102. When forming closed ends on the glass tube 102 and the glass article, the beam delivery system 420 may be configured to produce the laser beam 414 having an elliptical cross-section with a ratio of major axis to minor axis of from about 2 to about 12, such as from about 2 to about 10, from about 2 to about 8, from about 2 to about 5, or from about 2 to about 4 at the point along the beam path where the laser beam 414 is incident on the outer surface of the glass tube 102.

Referring again to FIG. 8, the thickness of the bottom of the glass article can be increased or decreased by increasing or decreasing the beam width of the laser beam 414 in the separating station 206, changing an orientation of the major axis of the laser beam 414 relative to the center axis A of the glass tube 102, or combinations thereof. Increasing the beam width of the laser beam 414 may increase the volume of glass heated in the separating region of the glass tube 102, which may result in a thicker meniscus formed over the end of the glass tube 102 and the end of the glass article separated therefrom. Thus, the thickness of the bottom of the glass article can be modified by changing the beam width of the laser beam 414. The beam width of the laser beam 414 may be increased or decreased by changing the distances between two or more lenses of the beam delivery system 420, by changing a distance between the laser system 410 and the glass tube 102 in the separating station 206, or both. Thus, the beam width of the laser beam 414 at the point where the laser beam 414 is incident on the glass tube 102 can be modified without changing lenses of the beam delivery system 420.

Additionally, referring again to FIG. 14, the volume of glass in the separating region heated by the laser beam 414 may be increased by changing the orientation of the laser beam 414 so that the major axis of the elliptical-shaped laser beam 414 is parallel to the center axis A of the glass tube 102, instead of or in addition to changing the beam width of the laser beam 414. Conversely, the volume of glass heated by the laser beam 414 may be decreased by changing the orientation of the laser beam 414 so that the major axis is perpendicular to the center axis A of the glass tube 102. The orientation of the laser beam 414 relative to the glass tube 102 can be modified by changing the orientation of one or more of the optical components of the beam delivery system 420 or by changing optical components of the beam delivery system 420.

In embodiments, separating the glass article from the working end 107 of the glass tube 102 may comprise decreasing the thickness of the bottom of the glass article. In embodiments, the laser beam 414 may be an elliptical laser beam, and decreasing the thickness of the bottom of the glass article may comprises orienting the laser beam 414 with a major axis of the laser beam 414 perpendicular to the center axis A of the glass tube 102, decreasing a beam width of the laser beam 414, or a combination thereof. In embodiments, separating the glass article from the working end 107 of the glass tube 102 further may comprise increasing the thickness of the bottom of the glass article. In embodiments, the laser beam 414 may be an elliptical beam, and decreasing the thickness of the bottom of the glass article may comprise orienting the laser beam 414 with a major axis of the laser beam 414 parallel to the center axis A of the glass tube 102, increasing a beam width of the laser beam 414, or a combination thereof.

Referring again to FIG. 16, as previously discussed, in embodiments, the separating station 206 may include the laser system 410 comprising two or more laser systems, such as the separating laser system 440 and the preheating laser system 450. In these embodiments, exposing the separating region 424 of the glass tube 102 to the laser beam may comprise exposing the separating region 424 of the glass tube 102 to two or more laser beams simultaneously in the separating station 206. In embodiments, the separating station 206 may comprise the separating laser system 440 operable to produce the separating laser beam 444 and the preheating laser system 450 operable to produce the preheating laser beam 454. Separating the glass article from the working end 107 of the glass tube 102 may include exposing the separating region 424 of the glass tube 102 to the preheating laser beam 454 and at the same time exposing the separating region 424 of the glass tube 102 with the separating laser beam 444. In embodiments, the separating laser beam 444 and the preheating laser beam 454 may be superimposed on the separating region 424 of the glass tube 102.

Exposing the separating region 424 of the glass tube 102 to the separating laser beam 444 and the preheating laser beam 454 at the same time may enable heating a greater volume of glass during separation of the glass article from the glass tube 102. The preheating laser beam 454 may further increase the heating rate of the glass in the separating region 424 of the glass tube 102, which may reduce the time required for separating the glass article from the glass tube 102. Further, in embodiments, exposing the separating region 424 of the glass tube to the separating laser beam 444 and the preheating laser beam 454 may enable greater control over the geometry of the bottom 112 (FIG. 20) of the glass article 103 and the heel 114 (FIG. 20) of the glass article 103 formed during separation. Referring to FIG. 20, the heel 114 is the portion of the glass article 103 that transitions between the bottom 112 and the sidewall 110.

Referring now to FIG. 15, in embodiments, the separating laser beam 444 may be an elliptical beam having a major axis and a minor axis, and the preheating laser beam 454 may be a round beam having a generally circular cross-section. The separating laser beam 444 and the preheating laser beam 454 may each have any of the other features, shapes, or properties previously discussed herein for laser beam 414.

Referring again to FIG. 16, the separating laser beam 444 may be oriented so that the major axis of the elliptical cross-section of the beam is perpendicular to the center axis A of the glass tube 102. In embodiments, the separating laser beam 444 and the preheating laser beam 454 may be axially aligned relative to the center axis A of the glass tube 102 so that the major axis of the separating laser beam 444 is aligned with a beam center of the preheating laser beam 454 (i.e., the major axis of separating laser beam 444 and beam center of the preheating laser beam 454 are disposed at the same axial position on the glass tube 102 when incident on the outer surface of the glass tube 102). In embodiments, the separating laser beam 44 may be axially offset relative to the beam center of the preheating laser beam 454. Axially offset means offset in a direction parallel to the center axis A of the glass tube 102 (i.e., in the −Z direction of the coordinate axis in FIG. 16) so that the major axis of the separating laser beam 444 is not aligned with the center of the preheating laser beam 454 at the point where the two beams are incident on the glass tube 102.

In embodiments, the separating laser beam 444 and the preheating laser beam 454 may be aligned horizontally (i.e., in the X-Y plane of FIG. 16) so that the minor axis of the separating laser beam 444 is aligned with the center of the preheating laser beam 454. In embodiments, the separating laser beam 444 and the preheating laser beam 454 may be horizontally centered on the glass tube 102 in the separating station 206. In FIG. 16, the separating laser beam 444 and the preheating laser beam 454 are shown as approaching the glass tube 102 from generally the same angular direction. Referring now to FIG. 17, in embodiments, the point where the separating laser beam 444 is incident on the glass tube 102 may be angularly offset from the point where the preheating laser beam 454 is incident on the glass tube 102. In other words, in embodiments, the minor axis of the separating laser beam 444 may be at a different angular position on the glass tube 102 compared to the beam center of the preheating laser beam 454. The separating laser beam 444 and the preheating laser beam 454 may be angularly offset by an angle alpha (α).

As previously discussed, exposing the separating region 424 of the glass tube 102 to both the separating laser beam 444 and the preheating laser beam 454 may increase the separation rate in the separating station 206, which may reduce the dwell time required for separating the glass article from the glass tube 102. Not intending to be bound by any particular theory, it is believed that exposing the separating region 424 to both the separating laser beam 444 and the preheating laser beam 454 simultaneously may increase the heating rate of the glass in the separating region 424 by increasing the energy density delivered to the glass in the separating region 424. This increased heating rate may reduce the time required to separate the glass article from the glass tube 102.

As previously discussed, exposing the separating region 424 of the glass tube 102 to the separating laser beam 444 and the preheating laser beam 454, simultaneously, may influence formation of the bottom of the glass article during separation of the glass article from the glass tube 102. In particular, the exposing the separating region 424 of the glass tube 102 to the preheating laser beam 454 in addition to the separating laser beam 444 may increase the volume of the glass heated during separation, which may increase the volume of glass and thickness of the meniscus formed over the ends of the glass tube 102 and glass article during separation. Further, the thickness of the bottom of the glass article separated from the glass tube 102 can be increased by increasing the beam diameter of the preheating laser beam 454, increasing a beam width of the separating laser beam 444, or a combination of both. Conversely, in embodiments, the thickness of the bottom of the glass article separated from the glass tube 102 can be decreased by decreasing the beam diameter of the preheating laser beam 454, decreasing a beam width of the separating laser beam 444, or a combination of both.

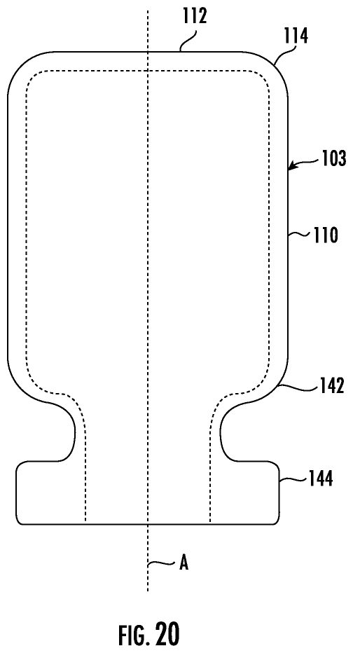

Referring now to FIG. 18, as previously discussed, in embodiments, the separating laser beam 444 may be axially offset from the preheating laser beam 454 so that the major axis 446 of the separating laser beam 444 is spaced apart in the axial direction (i.e., the +/−Z direction of the coordinate axis in FIG. 18) from the beam center 456 of the preheating laser beam 454. In embodiments, the major axis 446 of the separating laser beam 444 may be axially spaced apart from the beam center 456 of the preheating laser beam 454 by an axial offset G. Changing the axial offset G between the separating laser beam 444 and the preheating laser beam 454 may change the geometry of the bottom and the heel of the glass article.

Referring again to FIG. 20, a glass article 103 having a closed bottom (e.g., vial, jar, dish, ampoule, beaker, and the like) is graphically depicted. After separating the glass article 103 from the glass tube 102, the glass article 103 may comprise a sidewall 110, the bottom 112, and the heel 114, which is the transition from the sidewall 110 to the bottom 112. Referring to FIGS. 16 and 18, moving the separating laser beam 444 towards the working end 107 of the glass tube 102 (i.e., in the −Z direction of the coordinate axis in FIG. 18) relative to the preheating laser beam 454 so that the major axis 446 of the separating laser beam 444 is closer to the working end 107 of the glass tube 102 compared to the beam center 456 of the preheating laser beam 454 may result in a bottom 112 of the glass article 103 that is flatter (i.e., has greater flatness and less curvature) and/or a heel 114 with smaller heel radius compared to glass articles 103 separated by superimposing the separating laser beam 444 and the preheating laser beam 454 at the same axial location. The increasing the flatness of the bottom 112 and reducing the heel radius of the heel 114 may make the glass articles 103 more stable against rocking and falling over.

In embodiments, method of making the glass articles 103 may comprise modifying an axial position of the separating laser beam 444 relative to the axial position of the preheating laser beam 454. In embodiments, the methods may include moving the separating laser beam 444 towards the working end 107 of the glass tube 102 relative to a center of the preheating laser beam 454, wherein moving the separating laser beam 444 closer to the working end 107 of the glass tube 102 relative to the center of the preheating laser beam 154 may increase a flatness of the bottom 112 of the glass article 103, may decrease the heel radius of the heel 114 of the glass article 103, or both.

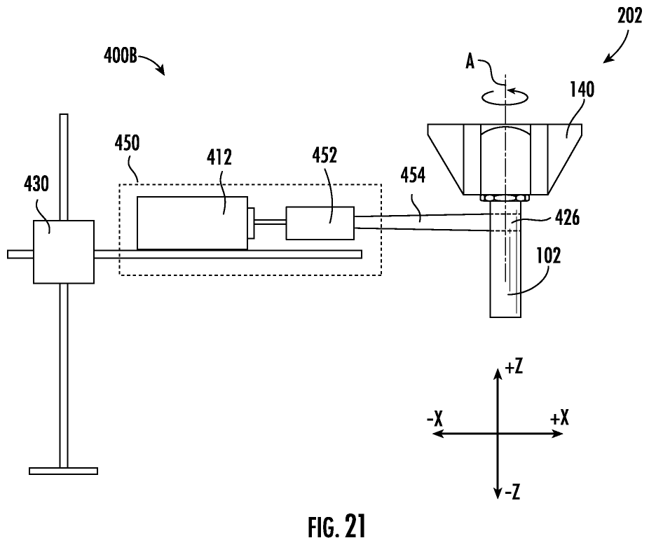

In embodiments, the preheating laser system 450 may be substituted with a burner in the separating station 206. Referring now to FIGS. 19A and 19B, in embodiments, the separating station 206 may comprise the separating laser system 440 and a burner 302. The separating laser system 440 may produce the separating laser beam 444. The burner 302 may be operable to provide additional heat to the separating region 424 of the glass tube 102. In embodiments, the burner 302 may be spaced apart from the separating laser beam 444 in an angular direction relative to the center axis A of the glass tube 102. In embodiments, the burner 302 may be oriented to heat a side of the glass tube 102 opposite the side heated by the separating laser beam 444. In embodiments, the gas burner 302 may be spaced apart from the separating laser beam 444 in the angular direction by from about 90 degrees to about 180 degrees, or about 180 degrees, where the angular direction is relative to the center axis A of the glass tube 102 in cylindrical coordinates. The burner 302 may have any of the features or characteristics previously disclosed herein for the burners 302.

When the separating station 206 comprises the separating laser system 440 and the gas burner 302, moving the separating laser beam 444 towards the working end 107 of the glass tube 102 relative to the burner 302 so that the major axis 446 of the separating laser beam 444 is closer to the working end 107 of the glass tube 102 compared to the flame from the gas burner 302 may result in a bottom 112 of the glass article 103 that is flatter (i.e., has greater flatness and less curvature) and/or a heel 114 with smaller heel radius compared to glass articles 103 separated by superimposing the separating laser beam 444 and the burner 302 at the same axial location. In embodiments, method of making the glass articles 103 may comprise modifying an axial position of the separating laser beam 444 relative to the axial position of the burner 302. In embodiments, the methods may include moving the separating laser beam 444 towards the working end 107 of the glass tube 102 relative to the burner 302, wherein moving the separating laser beam 444 closer to the working end 107 of the glass tube 102 relative to the burner 302 may increase a flatness of the bottom 112 of the glass article 103, may decrease the heel radius of the heel 114 of the glass article 103, or both.

Referring again to FIG. 3, the separating station 206 may be preceded by one or a plurality of heating stations 202 disposed upstream from the separating station 206. In embodiments, one or more of the heating stations 202 upstream of the separation station 206 may include a preheating laser system 450 operable to preheat the separating region of the glass tube 102 prior to translating the glass tube 102 into the separating station 206. The preheating laser system 450 may have any of the components or features previously described herein for the preheating laser system 450 associated with the separating station 206.

Referring now to FIG. 21, the preheating laser system 450 in the heating station 202 upstream of the separating station 206 may be operable to produce a preheating laser beam 454, which may be a round beam having a generally circular cross-section. The preheating laser beam 454 produced by the preheating laser system 450 the heating station 202 may have any of the features previously discussed herein for the laser beam 414. The method of producing the glass articles from the glass tubes 102 may include exposing the separating region 424 of the glass tube 102 to the preheating laser beam 454 in the heating station 202 disposed upstream of the separating station 206. In embodiments, the separating region of the glass tube 102 may be exposed to the preheating laser beam 454 in the separating station 206 and in the heating station 202 upstream of the separating station. In embodiments, the heating station 202 and the separating station 206 may each have a dedicated preheating laser system 450. In embodiments, the system 400 may comprise a single preheating laser system 450, which may include a beam splitter and multiple turning mirrors operable to split the preheating laser beam 454 into multiple beams and direct one preheating laser beam 454 to the glass tube 102 in the separating station 206 and direct another preheating laser beam 454 to the glass tube 102 in the heating station 202 upstream of the separating station 206.

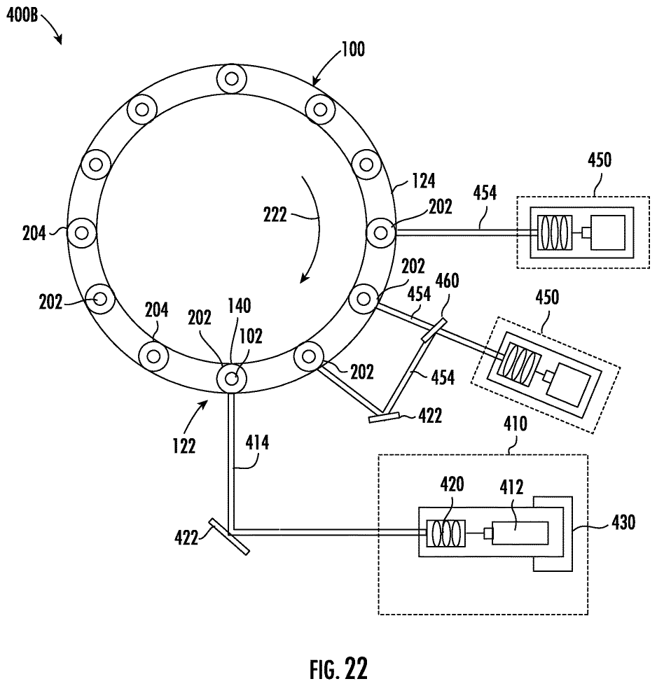

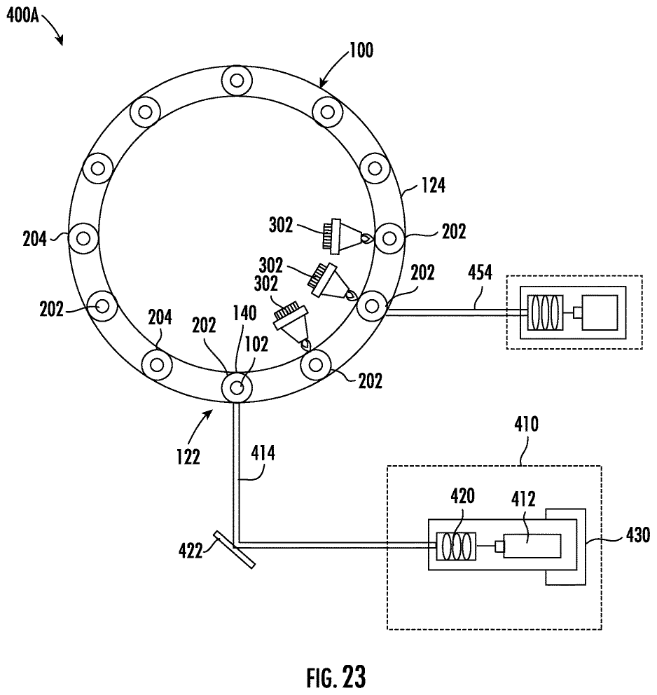

Referring now to FIG. 22, in embodiments, the separating station 206 and the heating stations 202 upstream of the separating station 206 may all have laser systems (e.g., separating laser system 410, preheating laser system 450 or both) for heating the glass tube 102 in the target region 424, the separating region 426, or both. In embodiments, the separating station 206 and heating stations 202 upstream of the separating station 206 do not include any burners 302 for heating the glass tube 102. Referring now to FIG. 23, in embodiments, the converter 100 may be a hybrid system in which the heating stations 202 upstream of the separating station 206 include a combination of preheating laser systems 450 and burners 302 for preheating the glass tube 102 prior to separation in the separating station 206. In embodiments, the heating station 202 immediately before the separating station 206 in the direction of rotation 222 may include at least one burner 302.

Referring again to FIGS. 1 and 8, the system 400 comprising the laser system 410 disposed in the separating station 206 may increase the overall part rate of the converter 100 by reducing the time needed to separate the glass articles 103 from the glass tube 102 in the separating station 206. In embodiments, the converter 100 of the system 400 may have an overall part rate that is greater than or equal to about 30 parts per minute, greater than or equal to about 35 parts per minute, greater than or equal to about 40 parts per minute, or even greater than or equal to about 60 parts per minute. In embodiments, the converter 100 of the system 400 may have an overall part rate that is from about 30 parts per minute to about 100 parts per minute.

In embodiments, the system 400 may have the laser system 410 for heating the glass tubes 102 disposed in any one of or all of the heating stations 202 of the converter 100. For instance, in embodiments, the system 400 may include laser systems 410 in one more of the heating stations 202 disposed upstream of the forming stations 204, and the laser systems 410 may be operable to heat target regions of the glass tube 102 with the laser beam 414 prior to contacting the glass tube with the forming tools. Exposing the target regions of the glass tubes 102 to the laser beam 414 may enable faster and more precise heating of the glass in the target regions of the glass tubes 102, which may provide for greater control over the final geometry and dimensions of the features of the glass articles formed in the forming stations 204. The laser system 410 disposed in the heating stations 202 and the laser beam 414 produced therefrom may have any of the features or properties previously described herein for laser system 410 and laser beam 414, respectively.

In embodiments, producing the glass articles from glass tubes 102 may include rotating the glass tube 102 about the center axis A of the glass tube 102; while rotating the glass tube 102, heating a target region of the glass tube 102 to a forming temperature with the laser beam 414; and after heating the target region of the glass tube 102, forming at least one feature of the glass article at the target region of the glass tube 102. Heating the target region of the glass tube 102 may comprise exposing the target region of the glass tube 102 with the laser beam 414 having a beam width of from about 0.5 mm to about 10 mm and a wavelength in a range of from about 1 μm to about 12 μm. Exposing the target region of the glass tube 102 to the laser beam 414 heats the glass at the target region to a temperature of greater than or equal to about 1000° C. In embodiments, the laser beam 414 in a heating station 202 may be a round beam having a circular cross-sectional shape.

In embodiments, the laser system 410 may be used further to polish the glass article following separation of the glass article from the glass tube. In embodiments, one or more of the processing stations in the secondary circuit of the converter 100 may comprise the laser system 410, which may be directed to one or more regions of the glass article to polish the glass article.

The systems 400 disclosed herein may be utilized in methods for separating glass articles from the working ends of glass tubes during converting and methods of forming glass articles from glass tubes in a converting process. Referring now to FIG. 8, a method for removing a glass article from the working end 107 of the glass tube 102 during converting may comprise translating the working end 107 of the glass tube 102 into the separating station 206 of the converter 100 (FIG. 1). Referring to FIG. 8, the methods may comprise rotating the glass tube 102 about the center axis A of the glass tube 102; while rotating the glass tube 102, exposing the separating region 424 of the glass tube 102 to the laser beam 414; and applying the axial force F to the glass article in a direction axially away from the glass tube 102 (i.e., in a direction in the −Z direction of the coordinate axis in FIG. 8). The laser beam 414 may have any of the properties previously discussed for laser beam 414 or separating laser beam 440. Exposing the separating region 424 of the glass tube 102 with the laser beam and applying the axial force F to the glass article separates the glass article from the working end 107 of the glass tube 102. The converter 100 may have any of the components or features previously discussed herein for the converter 100.

Referring to FIGS. 1, 8, and 20, methods disclosed herein for producing glass articles 103 from the glass tube 102 may comprise rotating the glass tube 102 about the center axis A of the glass tube 102; while rotating the glass tube 102, heating a target region 426 (FIG. 21) of the glass tube 102 to a forming temperature, wherein the target region 426 is proximate a working end 107 of the glass tube 102; after heating the target region 426 of the glass tube 102, forming at least one feature of the glass article 103 at the target region 426 of the glass tube 102, while rotating the glass tube 102; and separating the glass article 103 from the working end 107 of the glass tube 102 at the separating region 424 (FIG. 8) of the glass tube 102. Heating the target region 426 of the glass tube 102, separating the glass article 103 from the working end 107 of the glass tube 102, or both comprise exposing the target region 426, the separating region 424, or both of the glass tube 102 with the laser beam 414, which may have a largest cross-sectional dimension of less than or equal to about 1.25 times the outer diameter of the glass tube 102, such as from about 0.5 to about 1.25 times the outer diameter of the glass tube 102 at the point along the beam path where the laser beam 414 falls incident on the outer surface of the glass tubes 102 in the target region 426. In embodiments, the laser beam 414 may have a largest cross-sectional dimension of from about 5 mm to about 50 mm, or even greater than about 50 mm, at the point along the beam path where the laser beam 414 falls incident on the outer surface of the glass tubes 102 in the target region 426. Exposing the target region 426, the separating region 424, or both to the laser beam 414 may heat the glass tube 102 at the target region 426, the separating region 424, or both to a temperature of greater than or equal to about 1000° C.

Referring again to FIG. 21, in embodiments of the methods disclosed herein, heating the target region 426 of the glass tube 102 may comprise exposing the target region 426 to the laser beam 414 in a heating station 202 of a converter 100 (FIG. 1) for forming the glass articles from the glass tube 102. In the heating station 202, the laser beam 414 may be a heating laser beam. Referring again to FIG. 11, in embodiments, the laser beam 414 in the heating station 202 may have a circular cross-section. In embodiments, the laser beam 414 in the heating station 202 may have a cross-section having a diameter of up to about 1.25 times the outer diameter of the glass tube 102, such as from about 0.5 to about 1.25 times the outer diameter of the glass tube 102 at the point along the beam path where the laser beam 414 falls incident on the outer surface of the glass tubes 102. In embodiments, the laser beam 414 may have a cross-section having a diameter of from about 5 mm to about 50 mm, or even greater than about 50 mm, at the point along the beam path where the laser beam 414 is incident on the outer surface of the glass tubes 102.

Referring again to FIG. 8, in embodiments of the methods disclose herein, separating the glass article from the working end 107 of the glass tube 102 may comprise exposing the separating region 424 of the glass tube 102 to the laser beam 414 in the separating station 206 of the converter 100. In the separating station 206, the laser beam 414 may be a separating laser beam. In embodiments, the methods disclosed herein may further comprise exposing the separating region 424 of the glass tube 102 to a preheating laser beam in a heating station 202 before translating the glass tube 102 into the separating station 206. In embodiments, the heating station 202 comprising the heating laser beam may be directly upstream of the separating station 206.

Referring again to FIG. 8, in the separating station 206, the laser beam 414 may have any of the features or properties previously described herein for laser beam 414. In embodiments, the laser beam 414 in the separating station 206 may be a separating laser beam having an elliptical cross-section with a major axis and a minor axis. In embodiments, the separating laser beam in the separating station 206 may have a beam length of up to about 1.25 times the outer diameter of the glass tube 102, such as from about 0.5 to about 1.25 times the outer diameter of the glass tube 102 at the point along the beam path where the laser beam 414 is incident on the outer surface of the glass tubes 102. In embodiments, the laser beam 414 may have a beam length L_{B} of from about 5 mm to about 50 mm, or even greater than about 50 mm, at the point along the beam path where the laser beam 414 is incident on the outer surface of the glass tubes 102. The separating laser beam may have any of the features or properties previously disclosed herein for the laser beam 414. In embodiments, separating the glass article from the working end 107 of the glass tube 102 may comprise forming an open end on the bottom of the glass article where the bottom of the glass article is the end of the glass article previously coupled to the glass tube 102 prior to separation. Referring to FIG. 13, for producing an open end of the glass article, the separating laser beam may have a beam width of from about 0.5 mm to about 5 mm. In embodiments of forming open ends on the glass articles, the separating laser beam may be an elliptical beam having a ratio of major axis to minor axis of from about 4 to about 70.

In embodiments of the methods disclosed herein, separating the glass article from the working end 107 of the glass tube 102 may comprise forming the bottom 112 (FIG. 20) of the glass article 103 while separating the glass article 103 from the working end 107 of the glass tube 102. Referring to FIG. 12, forming the bottom on the glass article may comprise exposing the separating region 424 of the glass tube 102 to the laser beam 414 having a beam width of from about 3 mm to about 10 mm, a ratio of major axis to minor axis of from about 2 to about 12, or both. Referring to FIGS. 12 and 14, in embodiments, the laser beam 414 may be an elliptical beam and the major axis may be oriented parallel to or perpendicular to the center axis A of the glass tube 102.

Referring again to FIG. 12, in embodiments, the methods disclosed herein may comprise decreasing the thickness of the bottom of the glass article. Decreasing the thickness of the bottom of the glass article may comprise orienting the separating laser beam with a major axis of the separating laser beam perpendicular to the center axis A of the glass tube 102, decreasing the beam width of the separating laser beam, or a combination thereof. The separating laser beam may have a beam width of from about 5 mm to about 10 mm, or a ratio of a major axis to a minor axis of from about 2 to about 7, for decreasing the thickness of the bottom of the glass article. In embodiments, the methods disclosed herein may comprise increasing a thickness of the bottom of the glass article. For increasing the thickness of the bottom of the glass article, the separating laser beam may be an elliptical beam. Increasing the thickness of the bottom of the glass article may comprise orienting the separating laser beam with a major axis of the separating laser beam parallel to the center axis A of the glass tube 102, increasing a beam width of the separating laser beam, or a combination thereof. For increasing the thickness of the bottom of the glass article, the separating laser beam may have a beam width of from about 3 mm to about 7 mm, a ratio of major axis to minor axis of from about 2.5 to about 12, or both.

Referring now to FIG. 16, in embodiments, separating the glass article from the working end 107 of the glass tube 102 may comprise exposing the separating region 424 of the glass tube to the separating laser beam 444 having an elliptical cross-section and exposing the separating region 424 of the glass tube to a preheating laser beam 454 having a circular cross-section. The preheating laser beam 454 may be different from the separating laser beam 444. In embodiments, the methods may comprise superimposing the separating laser beam 444 and the preheating laser beam 454 on the separating region 424 of the glass tube 102. Referring now to FIG. 18, in embodiments, a center of the separating laser beam 444 may be offset in an axial direction (i.e., in the +/−Z direction of the coordinate axis in FIG. 18) relative to a center 456 of the preheating laser beam 454, wherein the axial direction is a direction parallel to the center axis A of the glass tube 102. In embodiments, the methods disclosed herein may include modifying an axial position of the separating laser beam 444 relative to an axial position of the preheating laser beam 454. Modifying the axial position of the separating laser beam 444 may be accomplished by adjusting one or more components of the separating beam delivery system 442 (FIG. 16), one or more turning mirrors 422, or combinations of these. Referring again to FIG. 18, in embodiments, the methods disclosed herein may include moving a vertical center (i.e., congruent with major axis 446) of the separating laser beam 444 toward the working end 107 of the glass tube 102 relative to the center 456 of the preheating laser beam 454, wherein moving the vertical center of the separating laser beam 444 closer to the working end 107 of the glass tube 102 relative to the center of the preheating laser beam 454 may increase a flatness of the bottom of the glass article 103 and may decrease a corner radius at a transition (i.e., heel 114 in FIG. 20) between the bottom and a sidewall of the glass article 103.

In embodiments of the methods disclosed herein, heating the target region of the glass tube 102, separating the glass article from the working end 107 of the glass tube 102, or both may include exposing the target region, the separating region, or both of the glass tube 102 with a first laser beam and, at the same time, exposing the target region, the separating region, or both of the glass tube with a second laser beam, wherein the first laser beam and the second laser beam are incident on the target region or the separating region of the glass tube 102. The first laser beam and the second laser beam may each have any of the features or properties previously described herein for laser beam 414. In embodiments, the methods may include superimposing the first laser beam and the second laser beam on the glass tube 102. In embodiments, the methods may further include modifying the axial position of the second laser beam relative to an axial position of the first laser beam. In embodiments, the first laser beam may have a circular beam cross-section, and the second laser beam may have an elliptical beam cross-section.

Referring again to FIG. 8, in embodiments, separating the glass article from the working end 107 of the glass tube 102 may comprise applying the pulling force F to the glass article while exposing the separating region 424 of the glass tube 102 to the laser beam 414. The pulling force F may move the glass article away from the glass tube 102 in the axial direction (i.e., in the −Z direction of the coordinate axis in FIG. 8). In embodiments, the glass tube 102 may be oriented vertically with the working end 107 of the glass tube 102 facing downward, and the pulling force may include the force of gravity. In embodiments, applying the pulling force F may comprise mechanically pulling the glass article in a direction axially away from the glass tube 102 (i.e., in the −Z direction of the coordinate axis of FIG. 8).

Referring again to FIGS. 5 and 6, in embodiments of the methods, the forming the features at the working end of the glass tube 102 may comprises contacting a surface of the glass tube 102 in the target region with one or more forming tools 324 while rotating the glass tube 102 about the center axis A of the glass tube. The contact between the forming tools 324 and the surface of the glass tube 102 may changes a shape of the glass tube 102 in the target region. Referring again to FIG. 1, in embodiments, the methods disclosed herein may further include operating the converter 100 to produce the plurality of glass articles 103 from the glass tubes 102. The converter 100 may include the plurality of processing stations 122 comprising at least one heating station 202, at least one forming station 204, and a separating station 206. Operating the converter 100 may comprise translating each of the glass tubes 102 through each of the plurality of processing stations 122 in succession. Heating the glass tube in at least one heating station 202, separating the glass article 103 from the working end 107 of the glass tube 102 in the separating station 206, or both may comprise exposing each of the glass tubes 102 to the laser beam 414 to heat each of the glass tubes 102 at the target region, the separating region, or both. In embodiments, the methods may further include securing the glass tube 102 in a holder 140 of the converter 100 comprising the plurality of processing stations 122. The converter 100 may translate the holder 140 and the glass tube 102 successively through each of the processing stations. The methods may further include forming one or more features of the glass article 103 at the working end 107 of the glass tube 102 by translating the glass tube 102 through the at least one heating station 202 and the at least one forming station 204 and separating the glass article 103 from the working end 107 of the glass tube 102 in the separating station 206. Heating the target region of the glass tube comprises exposing the target region of the glass tube to the laser beam 414 in the at least one heating station 202, or separating the glass article from the working end 107 of the glass tube 102 may comprise exposing the separating region of the glass tube 102 with the laser beam 414 in the separating station 206.

In embodiments, the glass articles may be pharmaceutical containers. In embodiments, the pharmaceutical containers may comprise vacutainers, cartridges, syringes, syringe barrels, ampoules, bottles, flasks, vials, tubes, beakers, or jars.

In embodiments, exposing the target region or the separating region of the glass tube 102 to the laser beam 414 may include producing the laser beam 414 using the laser source 412, passing the laser beam 414 through optics that modify a shape or power density distribution of the laser beam 414, and directing the laser beam 414 towards the target region or separating region of the glass tubes 102. The optics may comprise any of the optical components described for the beam delivery system 420. The optics may also comprise turning mirrors operable to direct the laser beam 414 towards the glass tube 102. The laser beam 414 may be a continuous laser beam or a pulsed laser beam. In embodiments, the laser beam 414 may be a collimated beam or an un-collimated beam. In embodiments, the laser beam 414 may comprise a laser power of from 50 W to 2000 W. In embodiments, the laser beam 414 may be an elliptical beam or a round beam. In embodiments, the laser beam 414 may have a wavelength in a range of from about 1 μm to about 12 μm, or from about 5 μm to about 11 μm.

In embodiments, the methods disclosed herein may include changing the shape of the laser beam 414, wherein changing the shape of the laser beam 414 may change the volume of glass heated in the target region or the separating region of the glass tube 102. The shape of the laser beam 414 may be changed by changing one or more optical components of the beam delivery system 420, by changing the distance between optical components of the beam delivery system 420, or both. In embodiments, the methods disclosed herein may include changing a power density of the laser beam 414, wherein changing the power density may change the heating rate of the laser beam 414. Increasing the power density may include increasing a power of the laser source 412 of the laser system 410. In embodiments, the methods may include controlling an exposure time of the glass tube 102 to the laser beam 414 during heating the target region of the glass tube 102, separating the glass article from the working end of the glass tube 102 or both by adjusting times at which a laser source 412 for producing the laser beam 414 is turned on and turned off. In embodiments, the laser beam may have a heating rate of from 200° C./second to 400° C./second. In embodiments, the methods may comprise rotating the glass tube 102 at a rotational speed of from 60 rpm to 400 rpm. The laser system 410 may increase the converting rate of the converter 100. In embodiments, the converting rate of the converter 100 for converting glass tubes 102 to glass articles may be greater than or equal to 30 parts per minute, greater than or equal to 35 parts per minute, or even greater than or equal to 40 parts per minute. In embodiments, the converting rate may be less than 30 parts per minutes, such as but not limited to when the glass tube 102 has a large outer diameter or greater wall thickness requiring additional dwell time per processing station to heat and/or form the glass article.

### EXAMPLES

The various embodiments of the systems and methods disclosed herein will be further clarified by the following examples. The examples are illustrative in nature, and should not be understood to limit the subject matter of the present disclosure.

### Examples 1-4: Changing Laser Power of Laser Beams

In Examples 1-4, the effects of modifying the power of the laser beam on the heating of the glass tube is evaluated. In Examples 1-4, glass tubes were heated with a laser beam on a bench top processing station configured to simulate a heating station of a converter. The bench top processing station included a holder (e.g., holder 140) operable to hold the glass tube and rotate the glass tube around the center axis of the glass tube. The bench top processing station included a laser system comprising a laser source, which was a CO₂ laser operable to produce a laser beam having a wavelength of 10.6 nm. The bench top processing station further included a thermal imaging system operable to obtain thermal images of the glass tube during heating and determine glass temperatures from the thermal images. The thermal imaging system and operation of the thermal imaging system to measure a temperature of glass can be found in U.S. Pat. No. 10,773,989, granted on Sep. 15, 2020, and entitled “Systems and Method for Measuring the Temperature of Glass During Tube Conversion,” the entire contents of which are incorporated by reference herein.

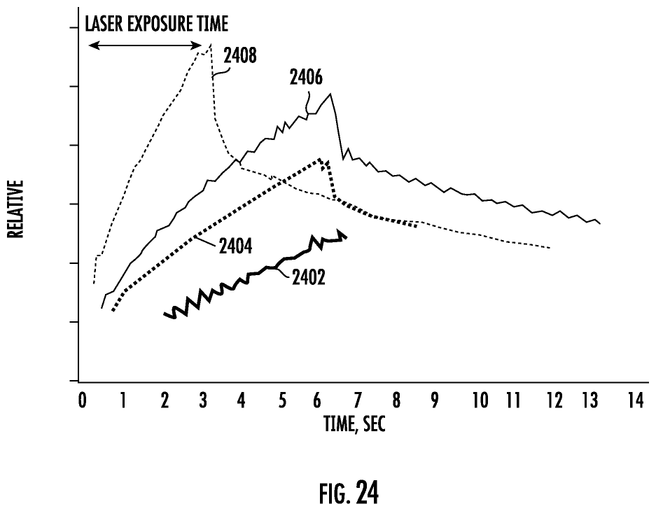

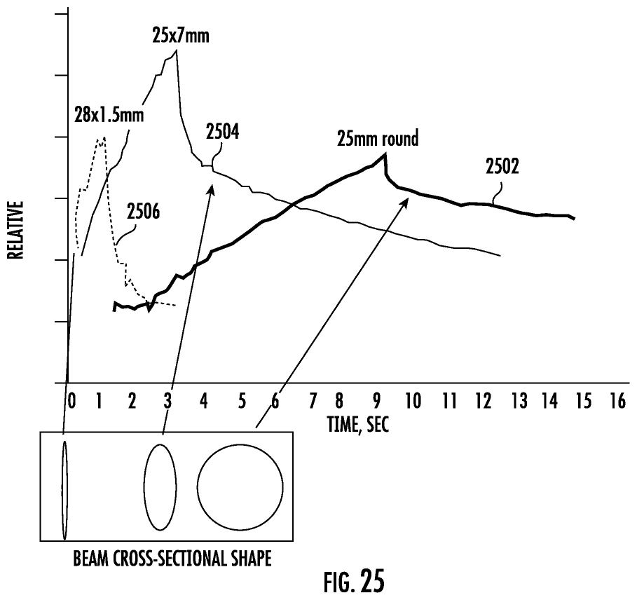

For each of Examples 1-4, a glass tube at room temperature was loaded into the holder in the bench top processing station and rotated. The glass tube size and composition and the rotational speed were the same for each of Examples 1-4. While rotating the glass tube, the laser system was turned on and the laser beam was directed towards the glass tube at a target location. The laser system and laser delivery system were configured to produce the laser beam having a wavelength of 10.6 nm and an elliptical cross-sectional shape. The laser power was different for each of Examples 1-4. Table 1 provides the laser power and the reference numbers in FIG. 24 for Examples 1-4. The glass tubes were the same for Examples 1-4. For each of Examples 1-4, the glass tube was heated with the laser beam from room temperature (i.e., no pre-heat) to a final temperature at which the laser source was switched off. The glass tubes were then allowed to cool for a period of time. For Examples 1-3, the laser exposure time was about 6.5 seconds. Due to the greater heating rate, the laser exposure time for Example 4, at 630 W, was reduced to about 3.5 seconds. The glass temperature was measured with the thermal imaging system during heating of the glass tube.

TABLE 1

| | Laser | Reference Number | Laser Exposure |
|---|---|---|---|
| Example | Power (W) | in FIG. 24 | Time (seconds) |
| 1 | 235 | 2402 | 6.5 |
| 2 | 360 | 2404 | 6.5 |
| 3 | 480 | 2406 | 6.5 |
| 4 | 630 | 2408 | 3.5 |

Referring now to FIG. 24, as the laser power is increased, the heating rate (i.e., the time required to heat the glass to temperatures at or greater than 1000° C.) also increases. As shown in FIG. 24, at a laser power of 630 W (Example 4), the temperature of the glass tube can be increased from room temperature to over 1000° C. in about 3 seconds. Preheating the glass tube upstream of the processing station comprising the laser system may further enable the final heating of the glass tube to be accomplished in less than 1 second, which can increase the part rate of the converting process.

### Examples 5-7: Changing Beam Shape

In Examples 5-7, the effects of beam shape on heating rate of the glass tube is evaluated. In Examples 5-7, glass tubes were heated with a laser beam using the bench top processing station and the method previously described in Examples 1-4. In Examples 5-7, the laser power was maintained constant at 630 W and the shape of the beam was modified for Examples 5-7. The glass tube was the same for each of Examples 5-7. The beam shapes and references numbers for FIG. 25 are provided below in Table 2.

TABLE 2

| Example | 5 | 6 | 7 |
|---|---|---|---|
| Reference number in | 2502 | 2504 | 2506 |
| FIG. 25 | | | |
| Beam shape | round | elliptical | elliptical |
| Beam diameter (mm) | 25 | N/A | N/A |
| Beam length (mm) | N/A | 25 | 28 |
| Beam width (mm) | N/A | 7 | 1.5 |

Referring now to FIG. 25, the heating and cooling curves for Examples 5-7 are shown. As indicated by FIG. 25, changing the shape of the laser beam at constant power density can also change the heating rate of the glass. For example, for the glass tube with diameter of 20-25 mm and wall thickness of 0.7-1.0 mm the heating rate can be about 200° C./second or even reach 400° C./second for a more focused beam, such as the narrow elliptical beam of Example 7 (ref. no. 2506). As a result, with glass tube pre-heat of up to 1000° C.-1100° C. at these heating rates reaching the process temperature for glass forming would be expected to take less than or equal to 1 second, which may translate into increased converting rates of greater than or equal to about 30 parts per minute, or even greater than or equal to about 60 parts/min. The converting rate can be even greater for glass tubes having thickness less than about 0.7 mm.

### Comparative Example 8: Separating with Closed Bottom Using a Gas Burner

In Comparative Example 8, a glass article was separated from the working end of the glass tube using a gas burner according to prior art separation methods. For Comparative Example 8, the bench-top processing station described in conjunction with Examples 1-4 was equipped with a bottom chuck operable to exert a pulling force on the glass article in a downward direction (i.e., in an axial direction away from the working end of the glass tube). The laser system was replaced with a gas burner for heating the glass tube for separation. The glass article was separated from the glass tube by heating the separating region of the glass tube with the gas burner and then applying the pulling force on the glass article. Separation caused the formation of a meniscus of glass on the end of the glass article, which formed a closed bottom on the end of the glass article.

### Example 9: Separating with Closed Bottom Using the Laser System

In Example 9, the laser system was used to separate the glass article from the glass tube and form a bottom on the end of the glass article separated from the glass tube. For Example 9, the the bench-top processing station described in conjunction with Examples 1-4 was equipped with a bottom chuck operable to exert a pulling force on the glass article in a downward direction (i.e., in an axial direction away from the working end of the glass tube). The laser system was used to heat the glass tube during separation. The glass article was separated from the glass tube by heating the separating region of the glass tube with the laser system and then applying the pulling force on the glass article. Separation caused the formation of a meniscus of glass on the end of the glass article, which formed a closed bottom on the end of the glass article.

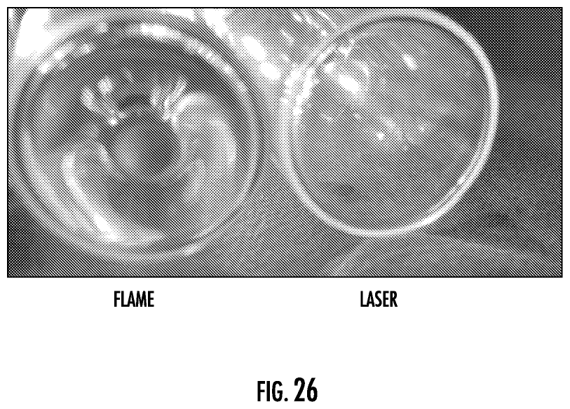

Referring now to FIG. 26, photographs of the bottoms formed on the glass article in Comparative Example 8 (left) and Example 9 (right) are shown. As shown in the image on the right, separation using the laser system in Example 9 produces a flatter bottom have less variation in thickness compared to the bottom formed by separating using a gas burner, as in Comparative Example 8 (left).

### Example 10: Separating to form an Open Bottom

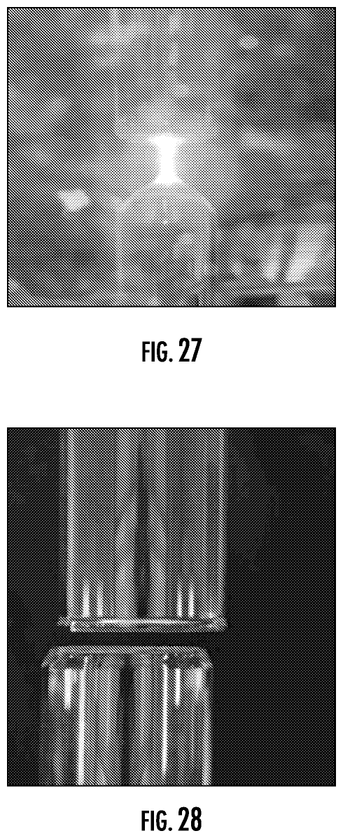

In Example 10, the laser system was used to separate a glass article from a working end of the glass tube while forming an open end on the glass article at the end separated from the glass tube. For Example 10, the bench-top processing station described in conjunction with Examples 1-4 was equipped with a bottom chuck operable to exert a pulling force on the glass article in a downward direction (i.e., in an axial direction away from the working end of the glass tube). The laser system included a beam delivery system operable to produce a narrow elliptical beam suitable to heat enough glass to separate the glass article from the glass tube, but not enough to form a meniscus over the ends of the glass article and glass tube after separation. Referring to FIG. 27, the photograph shows an image of the separation during application of the pulling force on the glass article at the moment just before separation. FIG. 28 shows the result of the tube separation of Example 10 without forming the bottom, which combines tube cutting and edge polishing steps into one process. As a result, clean and virtually defect free edges are obtained. Tube separation without bottom forming can also done via glass melting and application of the pulling force, but the volume of glass heated by the laser heating during separation in this case is just enough to produce a smooth tube edge, but not enough to form a bottom on the glass article. Varying the tube area affected by the laser beam and the laser power can enable different well-controlled forming procedures from clean cut and finishing to forming bottoms of different thicknesses using the same configuration of the laser system.

While various embodiments of the systems 100 and methods for cutting and finishing the ends of the glass tubes 102 using the systems 100 have been described herein, it should be understood that it is contemplated that each of these embodiments and techniques may be used separately or in conjunction with one or more embodiments and techniques.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method for producing glass articles from glass tubes, the method comprising:
rotating the glass tube about a center axis of the glass tube;
while rotating the glass tube, heating a target region of the glass tube to a forming temperature, wherein the target region is proximate a working end of the glass tube;
after heating the target region of the glass tube, forming at least one feature of the glass article at the target region of the glass tube, while rotating the glass tube; and
separating the glass article from the working end of the glass tube at a separating region of the glass tube;
wherein:
heating the target region of the glass tube, separating the glass article from the working end of the glass tube, or both comprise exposing the target region, the separating region, or both of the glass tube with a laser beam having a largest cross-sectional dimension at the point where the laser beam is incident on the glass tube of from about 0.5 to about 1.25 times an outer diameter of the glass tube; and
exposing the target region, the separating region, or both to the laser beam heats the glass tube at the target region, the separating region, or both to a temperature of greater than or equal to about 1000° C.

2-3. (canceled)

4. The method of claim 1, wherein separating the glass article from the working end of the glass tube comprises exposing the separating region of the glass tube to the laser beam in a separating station of a converter for forming the glass articles from the glass tubes, wherein the laser beam is a separating laser beam.

5-6. (canceled)

7. The method of claim 4, wherein the separating laser beam has a beam length of from 5 mm to 50 mm at a point where the separating laser beam is incident on the glass tube.

8. The method of claim 4, wherein separating the glass article from the working end of the glass tube further comprises forming an open end on a bottom of the glass article where the bottom of the glass article is the end of the glass article previously coupled to the glass tube prior to separation.

9. The method of claim 8, wherein the separating laser beam has a beam width of from about 0.5 mm to about 5 mm at a point where the separating laser beam is incident on the glass tube.

10. The method of claim 8, wherein the separating laser beam is an elliptical beam having a ratio of major axis to minor axis of from about 4 to about 70 at a point where the separating laser beam is incident on the glass tube.

11-14. (canceled)

15. The method of claim 4, wherein separating the glass article from the working end of the glass tube further comprises forming a bottom of the glass article while separating the glass article from the working end of the glass tube; and further comprising a step of decreasing a thickness of the bottom of the glass article, wherein the separating laser beam is an elliptical beam and decreasing the thickness of the bottom of the glass article comprises one or more of:
orienting the separating laser beam with a major axis of the separating laser beam perpendicular to the center axis of the glass tube;
decreasing a beam width of the separating laser beam;
or a combination thereof.

16-22. (canceled)

23. The method of claim 4, wherein separating the glass article from the working end of the glass tube further comprises forming a bottom of the glass article while separating the glass article from the working end of the glass tube; and further comprising a steps of:
modifying an axial position of the separating laser beam relative to an axial position of the preheating laser beam; and
moving a center of the separating laser beam toward the working end of the glass tube relative to a center of the preheating laser beam;
wherein moving the center of the separating laser beam closer to the working end of the glass tube relative to the center of the preheating laser beam increases a flatness of the bottom of the glass article and decreases a corner radius at a transition between the bottom and a sidewall of the glass article; and
wherein separating the glass article from the working end of the glass tub comprises: (1) exposing the separating region of the glass tube to a separating laser beam having an elliptical cross-section, and (2) exposing the separating region of the glass tube to a separating laser beam having a circular cross-section in the separating station.

24-28. (canceled)

29. The method of claim 1, wherein heating the target region of the glass tube, separating the glass article from the working end of the glass tube, or both comprises:
exposing the target region, the separating region, or both of the glass tube with a first laser beam; and
at the same time, exposing the target region, the separating region, or both of the glass tube with a second laser beam, wherein the first laser beam and the second laser beam are incident on the target region or the separating region of the glass tube.

30-46. (canceled)

47. The method of claim 1, comprising rotating the glass tubes at a rotational speed of from 60 rpm to 400 rpm.

48-49. (canceled)

50. A method for removing a glass article from a working end of a glass tube during converting, the method comprising:
translating the working end of the glass tube into a separating station of a converter;
rotating the glass tube about a center axis of the glass tube;
while rotating the glass tube, exposing a separating region of the glass tube a laser beam; and
applying an axial force to the glass article in a direction axially away from the glass tube;
where exposing the separating region of the glass tube with the laser beam and applying the axial force to the glass article separates the glass article from the working end of the glass tube.

51-56. (canceled)

57. The method of claim 50, wherein separating the glass article from the working end of the glass tube further comprises forming a bottom of the glass article while separating the glass article from the working end of the glass tube.

58-60. (canceled)

61. The method of claim 57, further comprising decreasing a thickness of the bottom of the glass article, wherein the separating laser beam is an elliptical beam and decreasing the thickness of the bottom of the glass article comprises one or more of:
orienting the separating laser beam with a major axis of the separating laser beam perpendicular to the center axis of the glass tube;
decreasing a beam width of the separating laser beam;
or a combination thereof.

62. (canceled)

63. The method of claim 57, comprising increasing a thickness of the bottom of the glass article, wherein the separating laser beam is an elliptical beam and increasing the thickness of the bottom of the glass article comprises one or more of:
orienting the separating laser beam with a major axis of the separating laser beam parallel to the center axis of the glass tube;
increasing a beam width of the separating laser beam;
or a combination thereof.

64. (canceled)

65. The method of claim 57, wherein separating the glass article from the working end of the glass tube comprises:
exposing the separating region of the glass tube to a separating laser beam having an elliptical cross-section; and
exposing the separating region of the glass tube to a preheating laser beam having a circular cross-section.

66-68. (canceled)

69. The method of claim 65, further comprising:
superimposing the separating laser beam and the preheating laser beam on the separating region of the glass tube; and
moving a center of the separating laser beam toward the working end of the glass tube relative to a center of the preheating laser beam;
wherein moving the center of the separating laser beam closer to the working of the glass tube relative to the center of the preheating laser beam increases a flatness of the bottom of the glass article and decreases a corner radius at a transition between the bottom and a sidewall of the glass article.

70. The method of claim 50, comprising rotating the glass tubes at a rotational speed of from 60 rpm to 400 rpm.

71. (canceled)

72. A system for producing glass articles from glass tubes, the system comprising:
a converter comprising a plurality of processing stations spaced apart in a circuit and at least one holder, wherein:
the plurality of processing stations comprise at least one heating station, at least one forming station, and a separating station;
the at least one holder is operable to hold a glass tube with a working end of the glass tube oriented towards the plurality of processing stations and to rotate the glass tube about a center axis of the glass tube; and
the converter is operable to translate the at least one holder having the glass tube secured therein through each of the plurality of processing stations in succession; and
a laser system disposed in the at least one heating station or the separating station, wherein:
the laser system comprises a laser source and a beam delivery system; and
the laser system is operable to generate a laser beam, modify one or more properties of the laser beam, and direct the laser beam at the glass tube when the glass tube is in the at least one heating station or the separating station.

73. The system of claim 72, wherein the at least one laser system comprises a plurality of laser systems, wherein the plurality of laser systems comprises at least one heating laser system disposed in the at least one heating station and a separating laser system disposed in the separating station.

74. The system of claim 72, wherein:
the laser system comprises a laser source and a beam delivery system;
the laser system is operable to produce the laser beam having a wavelength of from 1 μm to 12 μm and a power density of from 50 W to 2000 W; and
the beam delivery system is operable to modify a cross-sectional shape of the laser beam and direct the laser beam at the separating region of the glass tube in the separating station.

75-77. (canceled)

78. The system of claim 74, wherein the laser system further comprises at least one turning mirror, and wherein the laser system is disposed at a position where the laser beam does not have a straight path to the glass tube in at least one heating station or the separating station, and the at least one turning mirror is positioned to change the beam path of the laser beam so that the laser beam is incident on the target region or separating region of the glass tube.

79-83. (canceled)

84. The system of claim 72, wherein the laser system is disposed in the separating station and comprises:
a separating laser system operable to produce a separating laser beam having an elliptical cross-sectional shape; and
a preheating laser system operable to produce a preheating laser beam having a circular cross-sectional shape.

85. The system of claim 84, wherein the laser system is operable to superimpose the separating laser beam and the preheating laser beam on a separating region of the glass tube.

86-89. (canceled)
